(19) United States
(12) Patent Application Publication
(10) Pub. No.: US 2024/0205849 A1
(43) Pub. Date: Jun. 20, 2024

(54) TECHNIQUES TO FACILITATE SSB DESIGN FOR REDUCED CAPABILITY DEVICES IN A NON-TERRESTRIAL NETWORK

(71) Applicant: QUALCOMM Incorporated, San Diego, CA (US)

(72) Inventors: Lianghai JI, San Diego, CA (US); Huilin XU, Temecula, CA (US); Jing LEI, San Diego, CA (US); Jun MA, San Diego, CA (US); Qiang WU, San Diego, CA (US); Mohamad SAYED HASSAN, Paris (FR); Mehmet Izzet GURELLI, San Diego, CA (US); Weimin DUAN, San Diego, CA (US); Karthik ANANTHA SWAMY, La Jolla, CA (US)

(21) Appl. No.: 18/068,465

(22) Filed: Dec. 19, 2022

(51) Int. Cl. H04W 56/00; H04W 24/08

(52) U.S. Cl. CPC H04W 56/001; H04W 24/08; H04W 84/06

(57) ABSTRACT

Apparatus, methods, and computer-readable media for facilitating SSBs for reduced capability UEs in an NTN are disclosed herein. An example method for wireless communication at a UE includes monitoring in a first resource for at least a part of a first portion of a first SSB of a non-terrestrial network and a second portion of the first SSB, the first resource being associated with a first beam. The example method also includes monitoring for a second SSB of the non-terrestrial network on a second beam in a second resource that overlaps at least in part with the second portion of the first SSB.

### INTRODUCTION

The present disclosure relates generally to communication systems, and more particularly, to wireless communication employing synchronization signal blocks (SSBs) for reduced capability devices.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method may include monitoring in a first resource for at least a part of a first portion of a first synchronization signal block (SSB) of a non-terrestrial network and a second portion of the first SSB, the first resource being associated with a first beam. The example method may also include monitoring for a second SSB of the non-terrestrial network on a second beam in a second resource that overlaps at least in part with the second portion of the first SSB.

In another aspect of the disclosure, an apparatus for wireless communication is provided. The apparatus may be a UE that includes a memory and at least one processor coupled to the memory, the memory and the at least one processor configured to monitor in a first resource for at least a part of a first portion of a first SSB of a non-terrestrial network and a second portion of the first SSB, the first resource being associated with a first beam. The memory and the at least one processor may also be configured to monitor for a second SSB of the non-terrestrial network on a second beam in a second resource that overlaps at least in part with the second portion of the first SSB.

In another aspect of the disclosure, an apparatus for wireless communication at a UE is provided. The apparatus may include means for monitoring in a first resource for at least a part of a first portion of a first SSB of a non-terrestrial network and a second portion of the first SSB, the first resource being associated with a first beam. The example apparatus may also include means for monitoring for a second SSB of the non-terrestrial network on a second beam in a second resource that overlaps at least in part with the second portion of the first SSB.

In another aspect of the disclosure, a non-transitory computer-readable storage medium storing computer executable code for wireless communication at a UE is provided. The code, when executed, may cause a processor to monitor in a first resource for at least a part of a first portion of a first SSB of a non-terrestrial network and a second portion of the first SSB, the first resource being associated with a first beam. The example code, when executed, may also cause the processor to monitor for a second SSB of the non-terrestrial network on a second beam in a second resource that overlaps at least in part with the second portion of the first SSB.

In an aspect of the disclosure, a method of wireless communication at a network node is provided. The method may include outputting, on a first beam, a first SSB of a non-terrestrial network in a first resource, the first SSB including a first portion and a second portion. The example method may also include outputting a second SSB of the non-terrestrial network on a second beam in a second resource that that overlaps at least in part with the second portion of the first SSB.

In another aspect of the disclosure, an apparatus for wireless communication is provided. The apparatus may be a network node that includes a memory and at least one processor coupled to the memory, the memory and the at least one processor configured to output, on a first beam, a first SSB of a non-terrestrial network in a first resource, the first SSB including a first portion and a second portion. The memory and the at least one processor may also be configured to output a second SSB of the non-terrestrial network on a second beam in a second resource that that overlaps at least in part with the second portion of the first SSB.

In another aspect of the disclosure, an apparatus for wireless communication at a network node is provided. The apparatus may include means for outputting, on a first beam, a first SSB of a non-terrestrial network in a first resource, the first SSB including a first portion and a second portion. The example apparatus may also include means for outputting a second SSB of the non-terrestrial network on a second beam in a second resource that that overlaps at least in part with the second portion of the first SSB.

In another aspect of the disclosure, a non-transitory computer-readable storage medium storing computer executable code for wireless communication at a network node is provided. The code, when executed, may cause a processor to output, on a first beam, a first SSB of a non-terrestrial network in a first resource, the first SSB including a first portion and a second portion. The example code, when executed, may also cause the processor to output a second SSB of the non-terrestrial network on a second beam in a second resource that that overlaps at least in part with the second portion of the first SSB.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 shows a diagram illustrating an example disaggregated base station architecture.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and a UE in an access network.

FIG. 5A illustrates a first SSB and a second SSB, in accordance with various aspects of the present disclosure.

FIG. 5B illustrates a third SSB, accordance with various aspects of the present disclosure.

FIG. 5C illustrates a fourth SSB, in accordance with various aspects of the present disclosure.

FIG. 6 illustrates a first mapping and a second mapping of SSBs to symbol indexes, in accordance with various aspects of the present disclosure.

FIG. 7 is a diagram illustrating an example environment that may support wireless communication including aspects of a terrestrial network and a non-terrestrial network (NTN), in accordance with various aspects of the present disclosure.

FIG. 8 illustrates an example NTN cell supported by an aerial device, in accordance with various aspects of the present disclosure.

FIG. 9 illustrates an example communication flow between a network entity and a UE 904, in accordance with various aspects of the present disclosure.

FIG. 10 illustrates a mapping of a first SSB and a second SSB to time and frequency resources, in accordance with various aspects of the present disclosure.

FIG. 11 illustrates a mapping of a first SSB and a second SSB to time and frequency resources, in accordance with various aspects of the present disclosure.

FIG. 12 illustrates a mapping of a first SSB, a second SSB, and a third SSB to time and frequency resources, in accordance with various aspects of the present disclosure.

FIG. 13 illustrates a diagram including an aerial device providing service coverage to an NTN cell, in accordance with various aspects of the present disclosure.

FIG. 14 depicts a diagram illustrating an example of mapping SSBs to resources in which consecutive SSB indexes are associated with beams covering non-neighboring areas, in accordance with various aspects of the present disclosure.

FIG. 15 depicts a diagram illustrating an example of mapping SSBs to resources in which consecutive SSB indexes are associated with beams covering non-neighboring areas, in accordance with various aspects of the present disclosure.

FIG. 16 illustrates a diagram including an aerial device providing service coverage to an NTN cell, in accordance with various aspects of the present disclosure.

FIG. 17 depicts a diagram illustrating an example of mapping SSBs to resources in which consecutive SSB indexes are associated with beams covering non-neighboring areas, in accordance with various aspects of the present disclosure.

FIG. 18 depicts a diagram illustrating another example of mapping SSBs to resources in which consecutive SSB indexes are associated with beams covering non-neighboring areas, in accordance with various aspects of the present disclosure.

FIG. 19 depicts a diagram illustrating an example of mapping SSBs to resources while minimizing UE monitoring time, in accordance with various aspects of the present disclosure.

FIG. 20 depicts a diagram illustrating another example of mapping SSBs to resources while minimizing UE monitoring time, in accordance with various aspects of the present disclosure.

FIG. 21 is a flowchart of a method of wireless communication at a UE, in accordance with the teachings disclosed herein.

FIG. 22 is a flowchart of a method of wireless communication at a UE, in accordance with the teachings disclosed herein.

FIG. 23 is a diagram illustrating an example of a hardware implementation for an example apparatus and/or network entity.

FIG. 24 is a flowchart of a method of wireless communication at a network entity, in accordance with the teachings disclosed herein.

FIG. 25 is a flowchart of a method of wireless communication at a network entity, in accordance with the teachings disclosed herein.

FIG. 26 is a diagram illustrating an example of a hardware implementation for an example network entity.

### DETAILED DESCRIPTION

A network (e.g., a wireless communications network) may output one or more synchronization signal blocks (SSBs) to a UE, and the UE may process (e.g., decode) the SSBs in order to begin communications via the network. An SSB may be used to synchronize system information between the network and the UE, and may include synchronization signals, such as a primary synchronization signal (PSS), a physical broadcast channel (PBCH), and a secondary synchronization signal (SSS), which may be referred to as acquisition signals. The SSB may occupy resources in the time domain and/or the frequency domain. The PSS, the PBCH, and the SSS may each occupy different sets of symbols and subcarriers of the SSB. As used herein, a set of symbols and subcarriers includes a non-zero quantity of symbols and subcarriers.

Wireless communication systems, such as NR communication systems, may support higher capability UEs and reduced capability UEs. Among others, examples of higher capability UEs include premium smartphones, V2X devices, URLLC devices, eMBB devices, etc. Examples of reduced capability (RedCap) UEs include, among others, wearables (e.g., such as smart watches, augmented reality glasses, virtual reality glasses, health and medical monitoring devices, etc.), industrial wireless sensor networks (IWSN) (e.g., such as pressure sensors, humidity sensors, motion sensors, thermal sensors, accelerometers, actuators, etc.), surveillance cameras, low-end smartphones, etc. A RedCap UE may be referred to as an NR light device, a low-tier device, a lower tier device, etc.

A RedCap UE may operate with one or more of a reduced transmit power, a reduced number of transmit and/or receive antennas, a reduced transmit and/or receive bandwidth, or reduced computational complexity. An enhanced reduced capability (eRedCap) UE may have further reduced capabilities than a RedCap UE. For example, an eRedCap UE may be configured with a maximal radio frequency (RF) operating bandwidth, for example, of 5 MHz. However, an SSB may occupy more than the maximal RF operating bandwidth of an eRedCap UE. For example, an SSB may occupy a bandwidth of more than 5 MHz. In such scenarios, portions of the SSB may extend outside of the operational bandwidth of the eRedCap UE and, thus, the eRedCap UE may lack the ability to receive the full contents of the SSB. The maximal RF operating bandwidth may also be referred to as a “maximal bandwidth” or an “operational bandwidth.”

In some examples, a network may copy a portion of an SSB into adjacent symbols so that the full contents of the SSB may be received, for example, by a UE, such as an eRedCap UE. For example, an SSB may occupy four symbols in the time domain. The first symbol may span less than or equal to 12 resource blocks (RBs) in the frequency domain, and the remaining three symbols of the SSB may span 20 RBs in the frequency domain. In some examples, an eRedCap UE may be configured with a maximal RF operating bandwidth that corresponds to 5 MHz and/or may be configured to receive an SSB within its maximal RF operating bandwidth. In one example, the eRedCap UE with the maximal RF operating bandwidth of 5 MHz may only receive an SSB spanning 12 RBs in cases of a subcarrier occupying 30 kHz. For example, in scenarios in which the subcarrier spacing (SCS) is 30 kHz, an SSB spanning 12 RBs may occupy 4.32 MHz, which is within the operational bandwidth of an eRedCap UE with a maximal RF operating bandwidth of 5 MHz. In some such examples, the network may copy information outside of the 12 RBs of each of the three remaining symbols into adjacent symbols. For example, if an SSB occupies symbols 4 to 7 in the time domain, the network may copy portions of the SSB into symbols 2 and 3 preceding the SSB. In other examples, the network may copy the portions of the SSB into symbols 8 and 9 following the SSB.

In the above example, it may be appreciated that a first type of SSB may occupy four symbols, while a second type of SSB may occupy more than four symbols. In one example, the first type of SSB may also be referred to as a “legacy” SSB or a “Release-15” SSB. The first type of SSB may be configured for reception by non-RedCap UEs or higher capability UEs. In one example, the second type of SSB may also be referred to as a “RedCap” SSB. The second type of SSB may be configured and/or required for reception by a UE with reduced capabilities, such as a RedCap UE or an eRedCap UE. The RedCap SSB may include a first portion and a second portion. In one example, the first portion of the RedCap SSB may correspond to the four symbols of the first type of SSB and include the PSS, the SSS, and the PBCH. That is, the first portion of a RedCap SSB may be the same as a legacy SSB that may be received by a legacy non-RedCap UE. The second portion of the RedCap SSB may correspond to information of the first portion that is copied to adjacent symbols. For example, the second portion of the RedCap SSB may correspond to information of the first portion that is located outside the operational bandwidth (e.g., the maximal RF operating bandwidth) of the UE.

It may be appreciated that a UE with reduced capabilities may lack the ability to receive all of the first portion of a RedCap SSB as a subset of the first portion of the RedCap SSB may still extend outside of the maximal RF operating bandwidth of the UE. That is, a RedCap UE or an eRedCap UE may have the ability to receive only a subset of the first portion of a RedCap SSB that is corresponding to the four symbols of a legacy SSB, such as the part of the first portion that is within the maximal RF operating bandwidth of the UE.

In some examples, when a UE is attempting to receive an SSB, the UE first monitors for a PSS and an SSS of the SSB. For example, a UE with reduced capabilities may monitor for a first portion of a RedCap SSB that includes the PSS and the SSS. However, the UE with reduced capabilities may receive only a part of the PBCH of the RedCap SSB. For example, the operational bandwidth of a UE with reduced capabilities may enable the UE to receive the PSS, the SSS, and a portion of the PBCH. To receive the full contents of the SSB (e.g., the complete PSS, the complete SSS, and the complete PBCH), the UE may try two hypotheses to receive the remaining information of the SSB (e.g., the part of the SSB located outside of the operational bandwidth of the UE). According to one example, the UE may try a first hypotheses corresponding to adjacent symbols preceding the first portion of the RedCap SSB. According to another example, the UE may also try a second hypotheses corresponding to adjacent symbols succeeding (or following) the first portion of the RedCap SSB. Thus, when a UE with reduced capabilities detects the PSS and the SSS of an SSB, the UE may assume that the remaining contents of the SSB are located in symbols preceding the first portion of the SSB or in symbols succeeding the first portion of the SSB. In such scenarios, the UE may perform blind decoding for each of the hypotheses. For example, the UE may try to decode the remaining contents of the SSB using trial and error methods. It may be appreciated that performing blind decoding to try a hypothesis to receive the remaining contents of the SSB may increase UE complexity. Additionally, the part of the SSB that is copied into adjacent symbols occupies additional time domain symbols, which may introduce additional UE power consumption and UE complexity as the UE monitors more symbols to receive the full contents of the SSB. For example, a UE with the capability to receive a legacy SSB may monitor four symbols, while a UE with reduced capabilities may monitor eight symbols to receive a RedCap SSB.

In a terrestrial network (TN), a UE may receive an SSB via any transmitter antenna beam of a network entity, for example, due to signal reflection (e.g., when a signal reflects off of an object before reaching its intended target). Thus, transmission of SSBs in a TN may be configured such that resources used to transmit a first SSB do not overlap with resources used to transmit a second SSB. For example, with respect to an SSB, a first transmit antenna beam of a first network entity (e.g., a beam m) may transmit a first RedCap SSB. Additionally, a second transmit antenna beam of a second network entity (e.g., a beam n) may transmit a second RedCap SSB. In such scenarios, first resources (e.g., time resources and/or frequency resources) for the first RedCap SSB associated with the first transmit antenna beam may be different than second resources for the second RedCap SSB associated with the second transmit antenna beam (e.g., m≠n). That is, the first resources may be non-overlapping with the second resources. Otherwise, if the respective resources for the first RedCap SSB and the second RedCap SSB over different beams overlap, it may cause mutual interference (e.g., severe mutual interference), which may impact the ability of the UE to acquire an SSB. Thus, a terrestrial network may be limited in how different RedCap SSBs may be allocated to different beams so that the resources are not overlapping across the beams.

In addition to terrestrial networks, wireless communications systems may also support non-terrestrial networks (NTNs). An NTN may provide service coverage to areas where a terrestrial network may be unable to provide service coverage, such as rural areas. In an NTN, a UE may connect over-the-air (OTA) with a base station, or a component of a base station, via an aerial device.

Communication via an NTN wireless channel may be characterized via line of sight (LOS) propagation between the UE and the aerial device. In scenarios in which a signal may travel directly (e.g., without reflecting off of an object) between the UE and the aerial device, the NTN wireless channel may be characterized via strong LOS propagation. Even with LOS propagation, it is possible for a signal to reflect off an object before reaching its intended target (e.g., the UE or the aerial device). As the number of reflects increases and/or the degree with which the signal reflects of an object increases, the communication via the NTN wireless channel may be characterized via weak LOS propagation or non-LOS (NLOS) propagation.

According to one example, a signal from the aerial device may be reflected to the sky and, thus, a ground-based UE in an NTN may not receive and/or detect a NLOS signal. In contrast, a base station in a TN may direct a signal such that it is reflected/travels over a ground surface, which makes it possible for a ground-based UE to receive a strong NLOS signal.

Additionally, in an NTN, an aerial device may radiate different beams. Each of the different beams may be associated with respective footprints that have clear boundaries at the terrestrial-level (e.g., on the ground surface). As such, a UE may normally receive a signal from one beam of the aerial device while located within the footprint of the respective beam. However, in some scenarios, such as edge cases near the boundary of two footprints associated with two beams, the UE may receive signals from two beams. Whether the UE is located within a single footprint or near the boundary of two footprints, it is highly predictable from which beam of the aerial device a UE may receive a signal. That is, when a UE is located within a footprint, it may be assumed from which beam (or beams) the UE may receive signals.

As described above, NTN beams (e.g., one or more beams used for NTN communication between a UE and an aerial device) may be configured with distinct footprints on the ground. Such distinct footprints create opportunities for re-using resources associated with different beams for transmitting the second portion of a RedCap SSB (e.g., the information from the first portion that is copied into adjacent symbols). For example, a first footprint associated with a first beam may be overlapping with a second footprint associated with a second beam, and the first footprint may also be non-overlapping with a third footprint associated with a third beam. Thus, resources for the first beam may include a first portion of a first RedCap SSB, and resources for the third beam may overlap with one or more resources associated with a second portion of the first RedCap SSB. In such scenarios, since the footprints associated with the respective beams are distinct, concerns related to mutual interference between the resources for the first beam and the third beam may be reduced and/or negligible.

Aspects disclosed herein provide techniques for utilizing characteristics associated with an NTN to improve reception of SSBs for NTN reduced capability UEs (e.g., UEs with reduced capabilities operating in an NTN). For example, one or more aspects disclosed herein provide techniques for reducing power consumption of a UE with reduced capabilities, for example, by reducing the number of symbols that the UE may monitor to receive a RedCap SSB. Additionally, or alternatively, the techniques disclosed herein may reduce UE complexity, for example, by reducing the number of hypotheses that the UE with reduced capabilities may try when performing decoding of the RedCap SSB.

For purposes of this disclosure, an SSB may be described as containing a first portion and a second portion. The first portion of an SSB, sometimes referred to as an “SSB part-1,” a “primary portion,” or variants thereof, may refer to a legacy SSB. The first portion may be used by higher capability UEs and/or non-reduced capability UEs. The first portion may include some information that may not be received by a reduced capability UE, for example, due to the limited operational bandwidth of the reduced capability UE.

The second portion of an SSB, sometimes referred to as an “SSB part-2,” a “secondary portion,” or variants thereof, may refer to the part of the SSB that may not be received by a reduced capability UE, for example, due to the limited operational bandwidth of the reduced capability UE. The second portion may be replicated (e.g., copied) and placed in another time resource to enable the reduced capability UE to receive the full contents of the SSB. For example, the second portion may include PBCH information that is copied into adjacent symbols.

Aspects disclosed herein provide techniques for transmitting an SSB including a first portion and a second portion that may be received by a reduced capability UE operating in an NTN. For example, resources used for transmitting the second portion of a first SSB in a beam m may at least partially overlap with resources for transmitting a second SSB in a beam n, and where beam m and beam n are not a same beam. In one example, beam m and beam n are not a same beam of an aerial device, such as in an NTN. That is, aspects disclosed herein facilitate removing the restriction of avoiding two SSBs overlapping in a same resource, as described in connection with a terrestrial network. It may be appreciated that removing such a restriction may reduce UE power consumption and/or reduce UE complexity. For example, the second portion of the first SSB may be placed close in time with the first portion transmitted over the same beam. By placing the first portion and the second portion close in time, UE power consumption may be reduced, for example, by enabling the UE to enter and stay in a deep power-saving state for a longer time.

In some aspects, a distance between first resources for the first portion and second resources for the second portion transmitted over a same beam may be fixed in time. In such scenarios, a reduced capability UE may have the ability to locate the second portion after finding the first portion without having to try two hypotheses to locate the second portion. For example, after finding the first portion, the reduced capability UE may use the fixed distance in time to monitor for the second portion, which may facilitate reducing UE complexity and reducing UE power consumption.

In some aspects, SSB portions from different beams may overlap with each other, which may enable the reduced capability UE to monitor fewer symbols when searching for an SSB, which may facilitate reducing UE power consumption. For example, the second portion of a first SSB may be allocated to resources that overlap with the first portion of a second SSB. In such scenarios, the reduced capability UE may find the second portion of the first SSB while already looking for the first portion of the second SSB, thereby reducing the number of symbols that the reduced capability UE monitors when searching for the first SSB and the second SSB.

Although the following description provides examples directed to 5G NR, the concepts described herein may be applicable to other similar areas, such as 6G, 5G-advanced, LTE, LTE-A, CDMA, GSM, xG (where “x” represents a number), and/or other wireless technologies, in which a UE may be configured with a maximal RF operating bandwidth that is reduced compared to other UEs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

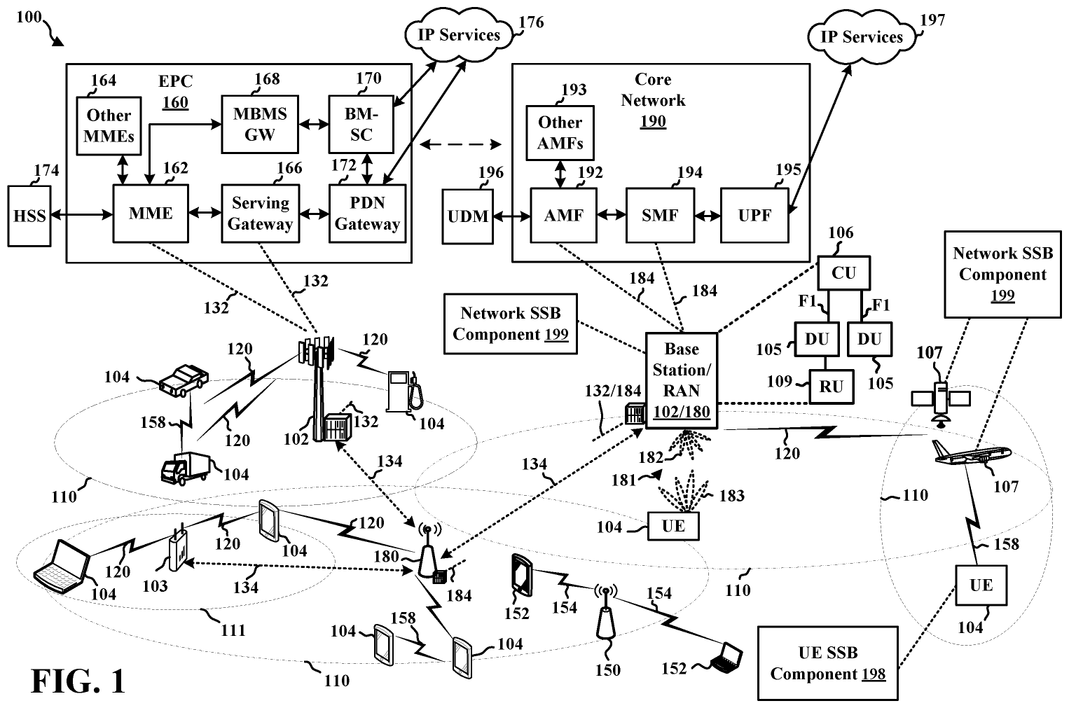

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell 103 may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 103 may operate in a licensed and/or an unlicensed frequency spectrum. When operating in an unlicensed frequency spectrum, the small cell 103 may employ NR and use the same unlicensed frequency spectrum (e.g., 5 GHz, or the like) as used by the Wi-Fi AP 150. The small cell 103, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 103 or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 181 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 182. The UEs 104 may receive the beamformed signal from the base stations 180 in one or more receive directions 183. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a wireless device, such as one of the UEs 104, may be in communication with a network entity, such as one of the base stations 102 or a component of a base station (e.g., a CU 106, a DU 105, and/or an RU 109), may be configured to manage one or more aspects of wireless communication. For example, the UEs 104 may include a UE SSB component 198 configured to facilitate receiving SSBs for at least UEs with reduced capabilities in an NTN.

In certain aspects, the UE SSB component 198 may be configured to monitor in a first resource for at least a part of a first portion of a first SSB of a non-terrestrial network and a second portion of the first SSB, the first resource being associated with a first beam. The example UE SSB component 198 may also be configured to monitor for a second SSB of the non-terrestrial network on a second beam in a second resource that overlaps at least in part with the second portion of the first SSB.

In another configuration, a network entity, such as an aerial device 107, one of the base stations 102, or a component of a base station (e.g., a CU 106, a DU 105, and/or an RU 109), may be configured to manage or more aspects of wireless communication. For example, the base stations 102 or the aerial device 107 may include a network SSB component 199 configured to facilitate transmitting SSBs at least for UEs with reduced capabilities in an NTN.

In certain aspects, the network SSB component 199 may be configured to output, on a first beam, a first SSB of a non-terrestrial network in a first resource, the first SSB including a first portion and a second portion. The example network SSB component 199 may also be configured to output a second SSB of the non-terrestrial network on a second beam in a second resource that that overlaps at least in part with the second portion of the first SSB.

The aspects presented herein may enable a UE improve SSB reception, which may facilitate reducing UE complexity and/or reducing UE power consumption.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

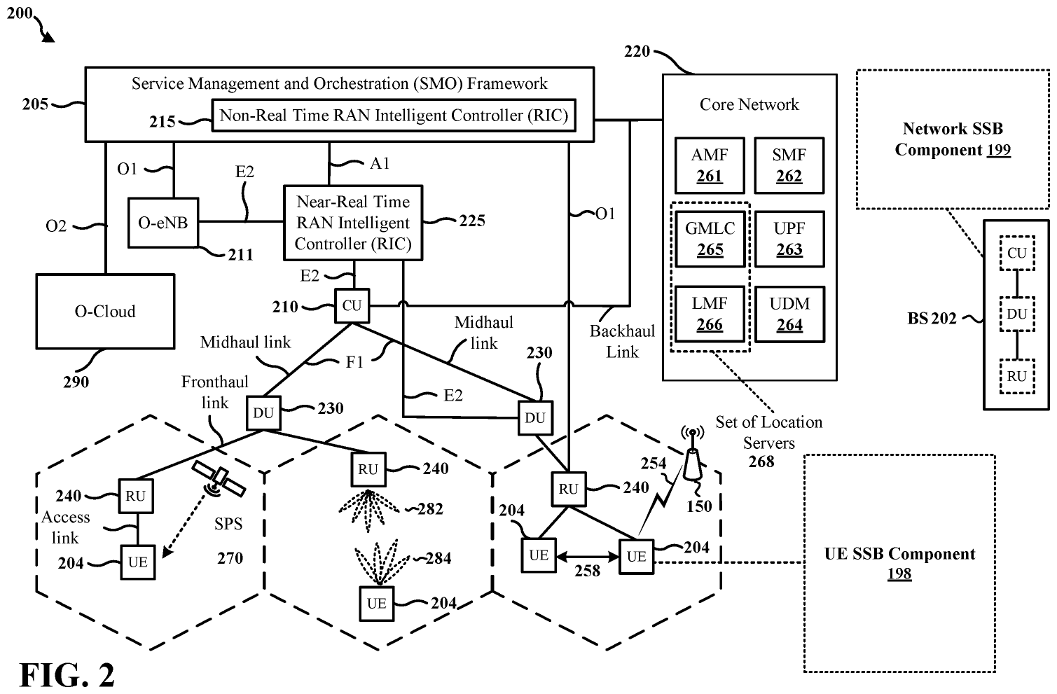

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC 215 associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUs (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UE 204 and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

A wireless device, such as the UE 204, may include the UE SSB component 198 configured to facilitate receiving SSBs for reduced capability UEs in an NTN, as described in connection with the example of FIG. 1.

In certain aspects, a base station, such as the disaggregated base station 200, or component of the base station, may include the network SSB component 199 configured to facilitate transmitting SSBs for reduced capability UEs in an NTN, as described in connection with the example of FIG. 1.

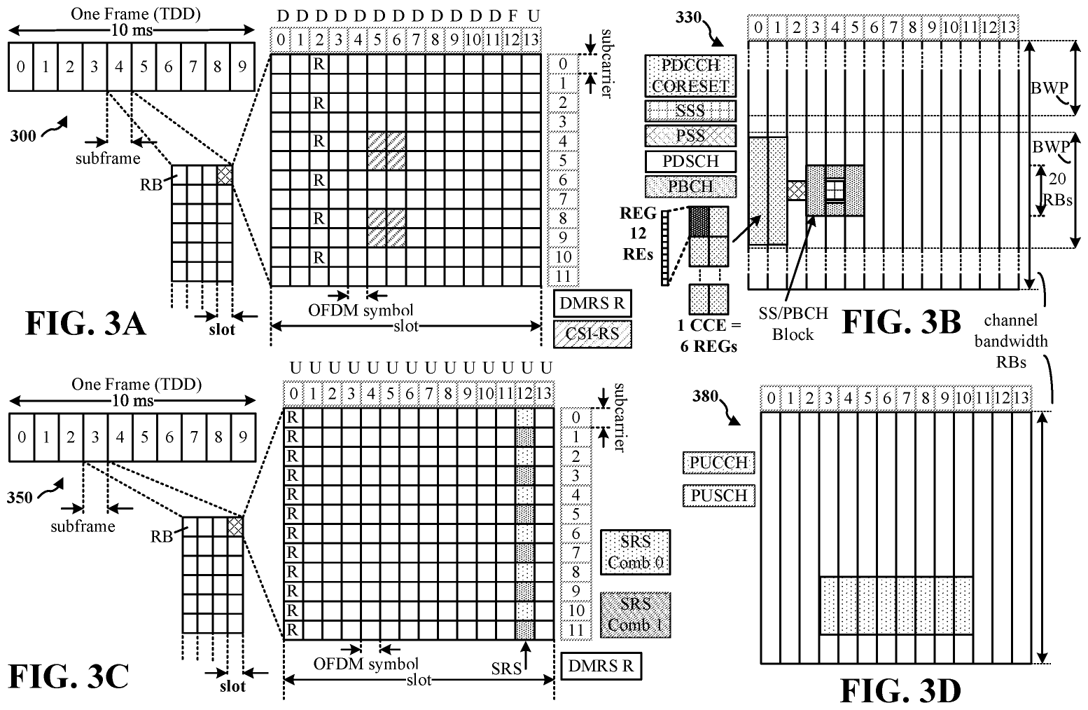

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

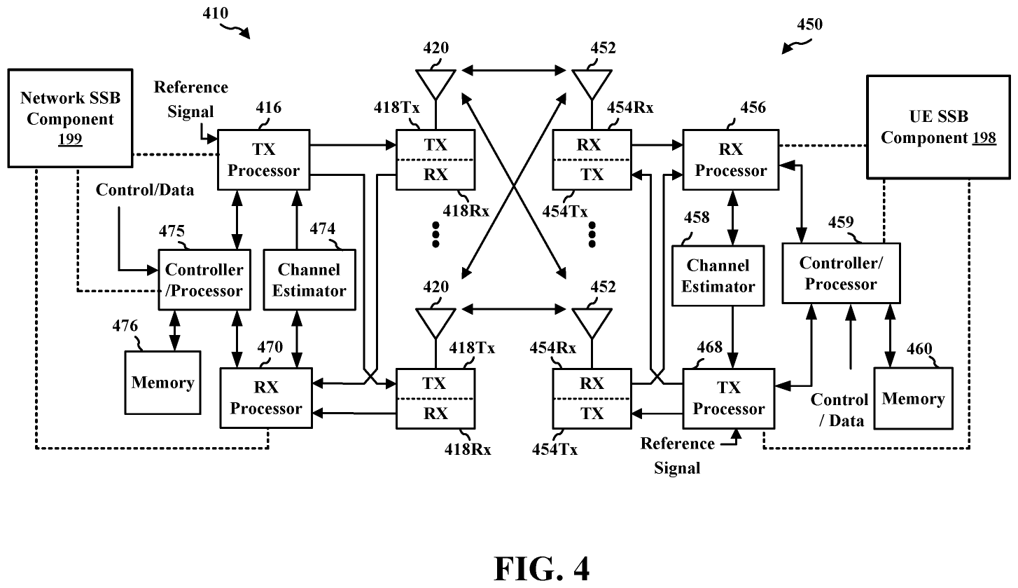

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and memory 476. The example UE 450 includes antennas 452, a transmitter 454Tx, a receiver 454Rx, an RX processor 456, a channel estimator 458, a controller/processor 459, memory 460, and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the UE SSB component 198 of FIG. 1 and/or FIG. 2.

At least one of the TX processor 416, the RX processor 470, and the controller/processor 475 may be configured to perform aspects in connection with the network SSB component 199 of FIG. 1 and/or FIG. 2.

As described above, wireless communication systems, such as NR communication systems, may support higher capability devices and reduced capability devices. A RedCap UE may communicate based on various types of wireless communication. For example, smart wearables may transmit or receive communication based on low power wide area (LPWA)/mMTC, IoT devices may transmit or receive communication based on URLLC, sensors/cameras may transmit or receive communication based on eMBB, etc. In some examples, a reduced capability UE may have an uplink transmission power that is less than that of a higher capability UE. As another example, a reduced capability UE may have reduced transmission bandwidth or reception bandwidth than other UEs. For instance, a reduced capability UE may have an operational bandwidth between 5 MHz and 20 MHz for both transmission and reception, in contrast to other UEs that may have a bandwidth of up to 100 MHz. As a further example, a reduced capability UE may have a reduced number of reception antennas in comparison to other UEs. Reduced capability UEs may additionally, or alternatively, have reduced computational complexity than other UEs.

An enhanced RedCap (eRedCap) UE may have further reduced capabilities than a RedCap UE. For example, an eRedCap UE may be configured with a maximal RF operating bandwidth, for example, of 5 MHz, in contrast to a RedCap UE, which may be configured with a maximal RF operating bandwidth of up to 20 MHz. It may be appreciated that a maximal RF operating bandwidth of 5 MHz for an eRedCap UE is merely illustrative and that other eRedCap UEs may have maximal RF operating bandwidths that are different than 5 MHz. An eRedCap UE with a reduced maximal RF operating bandwidth, compared to a RedCap UE, may have reduced computational complexity, which may provide benefits, such as reduced costs and reduced power consumption.

An eRedCap UE with a maximal RF operating bandwidth of 5 MHz may be unable to receive the full contents of an SSB when the SSB occupies a bandwidth of more than 5 MHz. In some examples, a part of the SSB may be copied in additional symbols so that an eRedCap UE may receive the full contents of the SSB. For example, a subset of the PBCH of a first SSB may extend outside of the maximal RF operating bandwidth (e.g., 5 MHz) of an eRedCap UE. In some such examples, the subset of the PBCH may be copied to additional symbols within a bandwidth that satisfies the maximal RF operating bandwidth of the eRedCap UE (e.g., within a bandwidth of 5 MHz) so that the eRedCap UE may receive the full contents of the first SSB. For example, a network may copy the subset of the PBCH in vacant symbols (e.g., one or more symbols not used for transmitting a second SSB over another beam) that are adjacent to the first SSB.

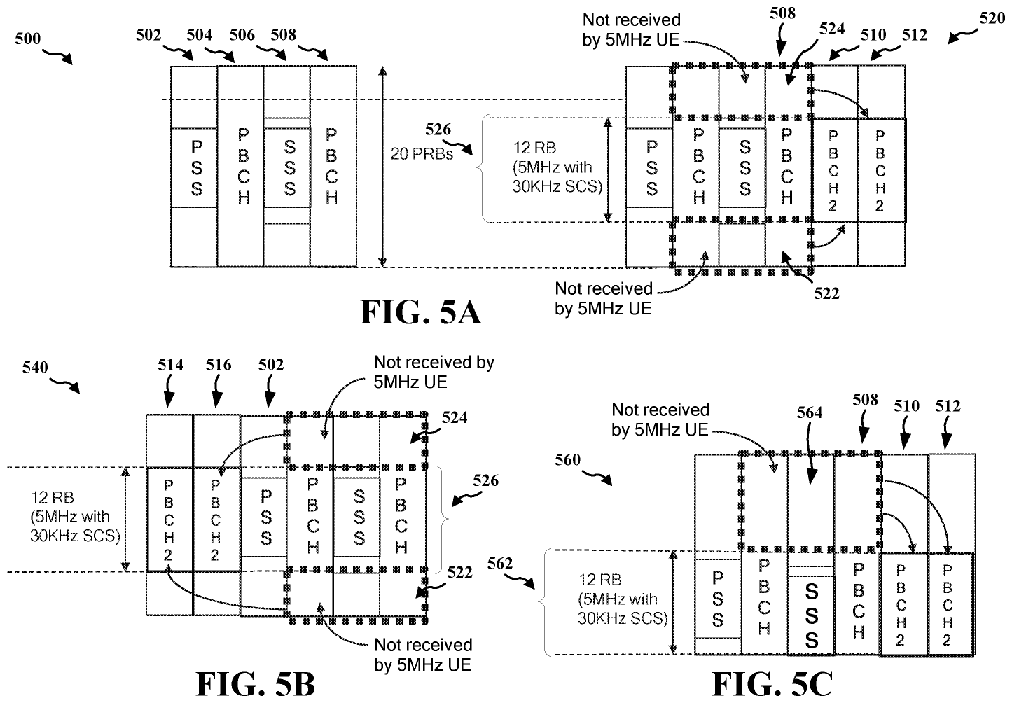

FIG. 5A illustrates a first SSB 500, as presented herein. In the illustrated example of FIG. 5A, the first SSB 500 occupies four consecutive symbols (e.g., a first symbol 502, a second symbol 504, a third symbol 506, and a fourth symbol 508) in the time domain and 20 consecutive RBs in the frequency domain. In the example of FIG. 5A, the first symbol 502 spans 12 RBs in the frequency domain and the remaining three symbols span 20 RBs. As shown in FIG. 5A, the first symbol 502 carries the PSS, the second symbol 504 carries a PBCH, the third symbol 506 carries an SSS, and the fourth symbol 508 carries another PBCH. In the example of FIG. 5A, PBCH RBs also occupy the remaining RBs of the third symbol 506 carrying the SSS, minus some guard subcarriers, as shown by the gaps between the PBCH RBs and the SSS in the third symbol 506. The PSS and the SSS in the first symbol 502 and the third symbol 506, respectively, include 12 RBs each, and there are a total of 24 PBCH RBs.

In examples in which the first SSB 500 is communicated in a frequency band with 15 kHz SCS, the first SSB 500 may occupy a bandwidth that is less than the maximal RF operating bandwidth of an eRedCap UE (e.g., less than 5 MHz). However, if the first SSB 500 is communicated in a frequency band with 30 kHz SCS (or higher), the first SSB 500 may occupy a bandwidth that is greater than the maximal RF operating bandwidth of an eRedCap UE and, thus, the eRedCap UE may be unable to receive all of the information of the first SSB 500. For example, parts of the PBCH RBs may extend outside the maximal RF operating bandwidth of the eRedCap UE.

FIG. 5A also illustrates an example of a second SSB 520, as presented herein. The second SSB 520 includes the information of the first SSB 500, including PSS, SSS, and PBCH in the first four symbols. In the illustrated example of FIG. 5A, the second SSB 520 is configured so that a portion of the PBCH of the SSB is copied in adjacent symbols. For example, a first portion 522 and a second portion 524 of the PBCH RBs of FIG. 5A each extend outside of a maximal RF operating bandwidth 526 of an eRedCap UE. To enable an eRedCap UE to receive the full contents of an SSB (e.g., the information contained in the PSS RBs, the SSS RBs, and the PBCH RBs of the first SSB 500), the second SSB 520 is configured so that the first portion 522 is copied in a first adjacent symbol 510 that is adjacent to the second SSB 520 (e.g., in a fifth symbol). Additionally, the second portion 524 is copied in a second adjacent symbol 512 that follows the first adjacent symbol 510 (e.g., in a sixth symbol). As shown in FIG. 5A, the first portion 522 and the second portion 524 each occupy less bandwidth than the maximal RF operating bandwidth 526.

As described above, the PSS and the SSS may each occupy 12 RBs and the PBCH may occupy 20 RBs. To support 30 kHz SCS, the 12 RBs associated with the PSS and the SSS may occupy less than 5 MHz, which may be the maximal RF operating bandwidth of an eRedCap. In such examples, the first portion 522 and the second portion 524 of the PBCH RBs may each occupy four RBs that are outside of the maximal RF operating bandwidth 526. Thus, the four RBs associated with the first portion 522 may be placed in a first symbol following the first SSB 500 (e.g., the first adjacent symbol 510). Additionally, the four RBs associated with the second portion 524 may be placed in a second symbol following the first SSB 500 (e.g., the second adjacent symbol 512).

It may be appreciated that the configuration of the second SSB 520, compared to the configuration of the first SSB 500, may have no impact on the ability of a non-eRedCap UE to receive the information of the SSB. For example, the first adjacent symbol 510 and the second adjacent symbol 512 contain copies of the first portion 522 and the second portion 524, respectively, and, thus, a non-eRedCap UE may obtain the information of the second SSB 520 based on receiving the first four symbols and without receiving the first portion 522 and the second portion 524.

Although the example of FIG. 5A illustrates copying the information of the first portion 522 in the first adjacent symbol 510 and copying the information of the second portion 524 in the second adjacent symbol 512, in other examples, the information of the first portion 522 may be copied in the second adjacent symbol 512, and the information of the second portion 524 may be copied in the first adjacent symbol 510.

FIG. 5B illustrates a third SSB 540, as presented herein. Aspects of the third SSB 540 may be similar to the second SSB 520 of FIG. 5A. For example, the third SSB 540 includes the same information as the first SSB 500, such as the PSS, the SSS, and the PBCH included in the four consecutive symbols 502-508. In contrast to the example of FIG. 5A, the third SSB 540 of FIG. 5B copies portions of the PBCH RBs into preceding symbols. For example, as shown in FIG. 5B, the third SSB 540 is configured so that the first portion 522 is copied in a third adjacent symbol 514 that is preceding the first symbol 502. Additionally, the second portion 524 is copied in a fourth adjacent symbol 516 that is also preceding the first symbol 502. As shown in the example of FIG. 5B, the first portion 522 and the second portion 524 each occupy less bandwidth than the maximal RF operating bandwidth 526.

Although the example of FIG. 5B illustrates copying the information of the first portion 522 into the third adjacent symbol 514 and copying the information of the second portion 524 into the fourth adjacent symbol 516, in other examples, the information of the first portion 522 may be copied in the fourth adjacent symbol 516, and the information of the second portion 524 may be copied in the third adjacent symbol 514.

In the illustrated example of FIG. 5A and FIG. 5B, the maximal RF operating bandwidth 526 is measured from the middle and, thus, there is the first portion 522 that extends below the maximal RF operating bandwidth 526 and the second portion 524 that extend above the maximal RF operating bandwidth 526. FIG. 5C illustrates a fourth SSB 560, as presented herein. In the example of FIG. 5C, the fourth SSB 560 includes PSS RBs, SSS RBs, and PBCH RBs that correspond to the respective portions of the first SSB 500 of FIG. 5A. As shown in FIG. 5C, a maximal RF operating bandwidth 562 is measured from the bottom and, thus, there is a third portion 564 that extends outside of the maximal RF operating bandwidth 562. In contrast, the examples of FIG. 5A and FIG. 5B each include two portions that each extend outside of the maximal RF operating bandwidth 526 of the second SSB 520 and the third SSB 540.

In the example of FIG. 5C, the third portion 564 occupies eight RBs. In some examples, the fourth SSB 560 may be configured so that the third portion 564 is copied into the first adjacent symbol 510 that is adjacent to the fourth symbol 508. The third portion 564 may occupy one symbol and also occupy less bandwidth than the maximal RF operating bandwidth 562. In some examples, the fourth SSB 560 may be configured so that a first subset of the third portion 564 may be copied into the first adjacent symbol 510 and a second subset of the third portion 564 may be copied into the second adjacent symbol 512 that is adjacent to the first adjacent symbol 510.

Although the example of FIG. 5C illustrates copying the additional portions into succeeding symbols, in other examples, the additional portions may be copied into preceding symbols, such as the example of FIG. 5B.

In some examples, the adjacent vacant symbols may precede or succeed the first SSB. For example, in a frequency band with 30 kHz SCS, the adjacent vacant symbols may precede or succeed the first SSB based on an SSB index. In some such scenarios, a UE may perform two hypotheses to determine the location of the additional PBCH symbols (e.g., the second portion of the first SSB) during SSB detection. That is, when an UE is monitoring for the first SSB, the UE may assume that there are two possible locations for the additional PBCH symbols (e.g., the second portion) associated with the first SSB (e.g., symbols preceding the first portion of the first SSB or symbols following the first portion of the first SSB). Thus, the UE may perform blind decoding for the preceding symbols and for the succeeding symbols. Performing blind decoding for the two possible locations (e.g., two hypotheses) may increase the level of computational complexity at the UE.

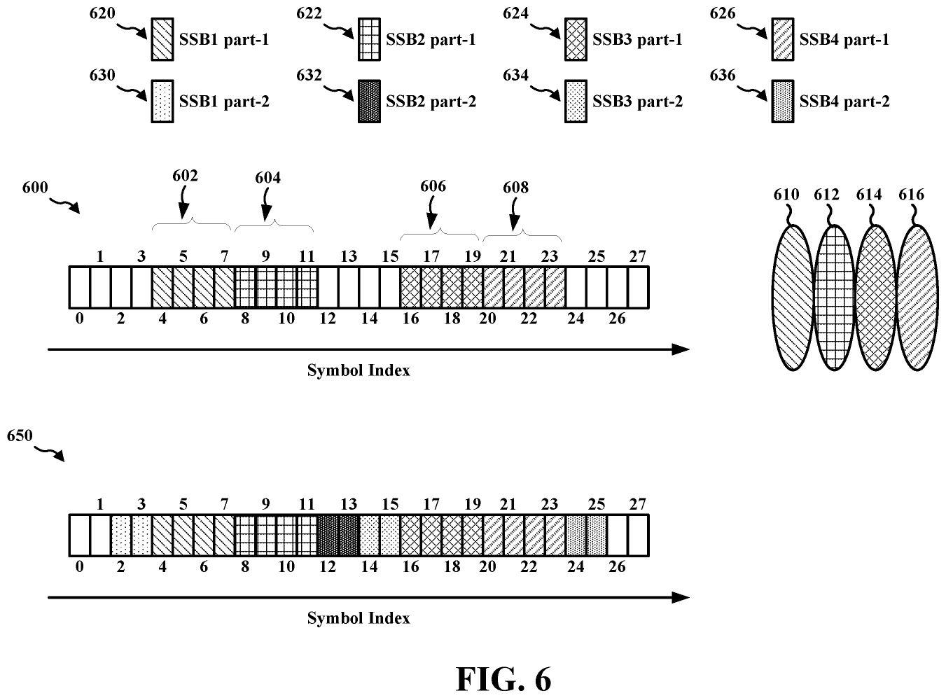

FIG. 6 illustrates a first mapping 600 and a second mapping 650 of SSBs to symbol indexes, as presented herein. In the example of FIG. 6, four example SSBs are transmitted via four SSB beams, including a first SSB beam 610, a second SSB beam 612, a third SSB beam 614, and a fourth SSB beam 616.

In the example of FIG. 6, the SSBs are mapped to symbol indexes based on a 30 kHz SCS. For example, for a 30 kHz SCS, the first symbols of candidate SSBs (e.g., symbols where an SSB may be received) have indexes {4, 8, 16, 20}+28n. In examples in which the carrier frequencies are smaller than or equal to 3 GHz, n is set to zero (e.g., n=0). In examples in which the carrier frequencies are within FR1 and that are larger than 3 GHz, n may be set to zero or one (e.g., n=0, 1).

In the illustrated example of FIG. 6, the first mapping 600 maps the SSBs to respective symbol indexes based on the 30 kHz SCS and with a carrier frequency smaller than or equal to 3 GHz (e.g., n=0). For example, the first symbol of a first SSB 602 maps to symbol 4, the first symbol of a second SSB 604 maps to symbol 8, the first symbol of a third SSB 606 maps to symbol 16, and the first symbol of a fourth SSB 608 maps to symbol 20.

The first mapping 600 illustrates the locations of the SSBs in a legacy system. For example, the SSBs are configured for a non-eRedCap UE (e.g., a UE with higher capabilities). That is, each of the SSBs of the first mapping 600 occupy four respective symbols, as described in connection with the first SSB 500 of FIG. 5A. Additionally, portions of the SSBs are not copied in adjacent symbols, as described in connection with the second SSB 520, the third SSB 540, and the fourth SSB 560 of FIG. 5A, FIG. 5B, and FIG. 5C, respectively.

In the illustrated example of FIG. 6, the second mapping 650 maps the SSBs to respective symbol indexes based on the 30 kHz SCS, with a carrier frequency smaller than or equal to 3 GHz (e.g., n=0), and configured for eRedCap UEs. For example, a portion of the respective SSBs may be copied into adjacent symbols to facilitate reception of the full contents of the SSB.

Similar to the example of the first mapping 600, the first symbols of the SSBs of the second mapping 650 have indexes {4, 8, 16, 20}. The second portion of the SSB (e.g., “part-2”) of each of the respective SSBs may be copied in adjacent symbols that are preceding or succeeding the first portions (e.g., “part-1”) of each of the SSBs. In the illustrated example of FIG. 6, the second portions of the first SSB 602 and the third SSB 606 are each copied into adjacent symbols that are preceding the first portions of the respective SSBs. For example, a first SSB part-1 620 (“SSB1 part-1”) (which may also be referred to as the first SSB 602) occupies symbols 4 to 7, and a first SSB part-2 630 (“SSB1 part-2”) of the first SSB occupies symbols 2 and 3, which are preceding the symbols of the first SSB part-1 620. Similarly, a third SSB part-1 624 (“SSB3 part-1”) (which may also be referred to as the third SSB 606) occupies symbols 16 to 19, and a third SSB part-2 634 (“SSB3 part-2”) of the third SSB occupies symbols 14 and 15, which are preceding the symbols of the third SSB part-2 634.

In the example of FIG. 6, the second portions of the second SSB 604 and the fourth SSB 608 are each copied into adjacent symbols that are succeeding the first portions of the respective SSBs. For example, a second SSB part-1 622 (“SSB2 part-1”) (which may also be referred to as the second SSB 604) occupies symbols 8 to 11, and a second SSB part-2 632 (“SSB2 part-2”) occupies symbols 12 and 13, which are succeeding the symbols of the second SSB part-1 622. Similarly, a fourth SSB part-1 626 (“SSB4 part-1”) (which may also be referred to as the fourth SSB 608) occupies symbols 8 to 11, and a fourth SSB part-2 636 (“SSB4 part-2”) occupies symbols 24 and 25, which are succeeding the symbols of the fourth SSB part-1 626.

In some examples, when a UE is performing an initial access procedure and/or an asynchronous neighbor cell search procedure, the UE may be unaware of the SSB index of the cell beforehand. For example, the UE may not know whether it is looking for a first SSB or a second SSB. In another example, the UE may not know the timing information of the cell. A higher capability UE that is configured with the ability to receive the first type of SSB (e.g., a legacy SSB, such as the first SSB 500 of FIG. 5A or based on the first mapping 600 of FIG. 6), may blindly monitor the symbols for searching and/or detecting an SSB.

However, a reduced capability UE that lacks the ability to receive the first type of SSB, but is configured with the ability to receive the second type of SSB (e.g., a RedCap SSB, such as the second SSB 520, the third SSB 540, and the fourth SSB 560 of FIG. 5A, FIG. 5B, and/or FIG. 5C), may try two hypotheses to receive the second portion of the respective SSB. For example, and with respect to the first SSB 500 of FIG. 5A, after detecting the PSS portion and the SSS portion of the first SSB (e.g., the first SSB part-1 620), the reduced capability UE may try a first hypotheses in which the first SSB part-2 630 may precede the first SSB part-1 620 (e.g., symbols 2 and 3). In a second hypotheses, the first SSB part-2 630 may follow the first SSB part-1 620 (e.g., symbols 8 and 9).

In addition to trying two hypotheses when monitoring for an SSB, the reduced capability UE monitoring for the RedCap SSB is also monitoring additional symbols compared to the higher capability UE, which results in increasing the UE monitoring time and, therefore, the power consumption of the UE. Such techniques for receiving a RedCap SSB, thus, may increase UE complexity and/or may deteriorate performance. For example, instead of monitoring four symbols for an SSB, the reduced capability UE may try two hypotheses and monitor six symbols. In one example, the mentioned problem may occur when the UE knows the timing information of the cell transmitting the SSB. For example, the UE may know the timing information corresponding to symbol 4 and associated with the first SSB 602.

As described above, transmission of SSBs in a TN may be configured so that resources used to transmit a first SSB do not overlap with resources used to transmit a second SSB. For example, and with respect to an SSB, a first transmit antenna beam of a first network entity (e.g., a beam m) may transmit a first RedCap SSB. Additionally, a second transmit antenna beam of a second network entity (e.g., a beam n) may transmit a second RedCap SSB. In such scenarios, first resources for the first RedCap SSB associated with the first transmit antenna beam may be different than second resources for the second RedCap SSB associated with the second transmit antenna beam (e.g., m #n). For example, and referring to the second mapping 650 of FIG. 6, each of the second portions of the SSBs representing the copied PBCH information is neither overlapping with the second portion of another SSB nor overlapping with the first portion of another SSB. Additionally, if the first SSB part-2 630 of the first SSB were moved from preceding symbols (e.g., symbols 2 and 3) to succeeding symbols (e.g., symbols 8 and 9), then the first SSB part-2 630 would overlap with resources of the second SSB part-1 622, which would result in mutual interference.

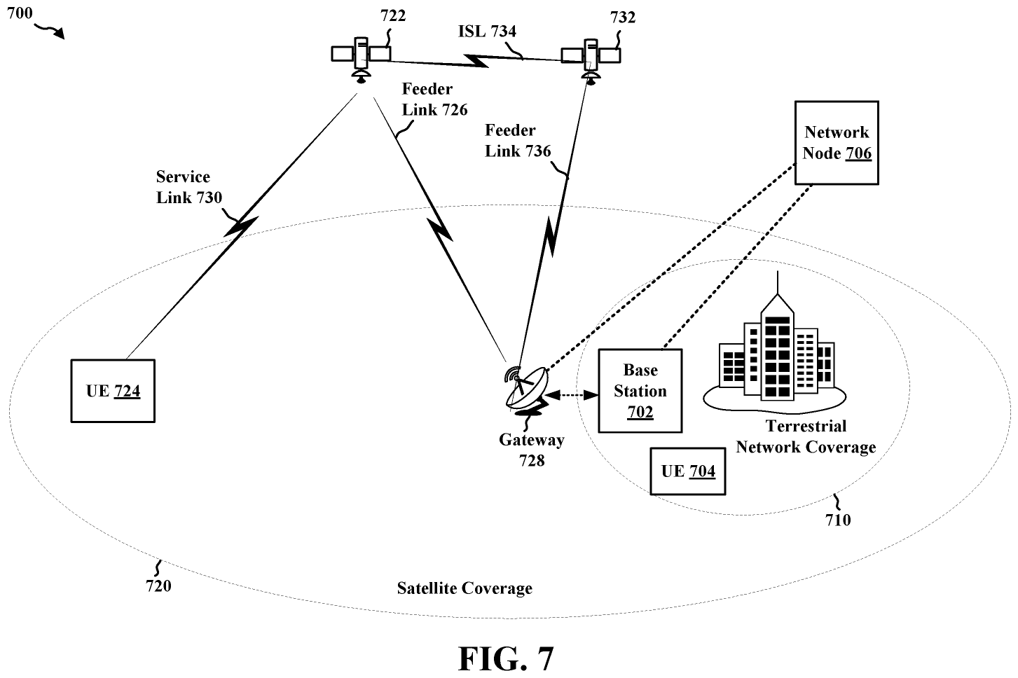

FIG. 7 is a diagram illustrating an example environment 700 that may support wireless communication including aspects of a terrestrial network and a non-terrestrial network, as presented herein. To enable communication with a UE, a number of approaches may be utilized.

In some examples, a UE may communicate with a terrestrial network. In the illustrated example of FIG. 7, a terrestrial network includes a base station 702 that provides coverage to UEs, such as an example UE 704, located within a coverage area 710 for the terrestrial network. The base station 702 may facilitate communication between the UE 704 and a network node 706. Aspects of the network node 706 may be implemented by a core network, such as the example core network 190 of FIG. 1.

In some examples, a UE may transmit or receive satellite-based communication (e.g., via an Iridium-like satellite communication system or a satellite-based 3GPP NTN). For example, an aerial device 722 may provide coverage to UEs, such as an example UE 724, located within a coverage area 720 for the aerial device 722. In some examples, the aerial device 722 may communicate with the network node 706 through a feeder link 726 established between the aerial device 722 and a gateway 728 in order to provide service to the UE 724 within the coverage area 720 of the aerial device 722 via a service link 730. The feeder link 726 may include a wireless link between the aerial device 722 and the gateway 728. The service link 730 may include a wireless link between the aerial device 722 and the UE 724. In some examples, the gateway 728 may communicate directly with the network node 706. In some examples, the gateway 728 may communicate with the network node 706 via the base station 702.

In some aspects, the aerial device 722 may be configured to communicate directly with the gateway 728 via the feeder link 726. The feeder link 726 may include a radio link that provides wireless communication between the aerial device 722 and the gateway 728.

In other aspects, the aerial device 722 may communicate with the gateway 728 via one or more other aerial devices. For example, the aerial device 722 and a second aerial device 732 may be part of a constellation of satellites (e.g., aerial devices) that communicate via inter-satellite links (ISLs). In the example of FIG. 7, the aerial device 722 may establish an ISL 734 with the second aerial device 732. The ISL 734 may be a radio interface or an optical interface and operate in the RF frequency or optical bands, respectively. The second aerial device 732 may communicate with the gateway 728 via a second feeder link 736.

In some examples, the aerial device 722 and/or the second aerial device 732 may include an aerial device, such as an unmanned aircraft system (UAS), a balloon, a drone, an unmanned aerial vehicle (UAV), etc. Examples of a UAS platform that may be used for NTN communication include systems including Tethered UAS (TUA), Lighter Than Air UAS (LTA), Heavier Than Air UAS (HTA), and High Altitude Platforms (HAPs). In some examples, the aerial device 722 and/or the second aerial device 732 may include a satellite or a space-borne vehicle placed into Low-Earth Orbit (LEO), Medium-Earth Orbit (MEO), Geostationary Earth Orbit (GEO), or High Elliptical Orbit (HEO).

In some aspects, the aerial device 722 and/or the second aerial device 732 may implement a transparent payload (sometimes referred to as a “bent pipe” payload). For example, after receiving a signal, a transparent aerial device may have the ability to change the frequency carrier of the signal, perform RF filtering on the signal, and amplify the signal before outputting the signal. In such aspects, the signal output by the transparent aerial device may be a repeated signal in which the waveform of the output signal is unchanged relative to the received signal.

In other aspects, the aerial device 722 and/or the second aerial device 732 may implement a regenerative payload. For example, a regenerative aerial device may have the ability to perform all of or part of the base station functions, such as transforming and amplifying a received signal via on-board processing before outputting a signal. In some such aspects, transformation of the received signal may refer to digital processing that may include demodulation, decoding, switching and/or routing, re-encoding, re-modulation, and/or filtering of the received signal.

In examples in which the aerial device implements a transparent payload, the transparent aerial device may communicate with the base station 702 via the gateway 728. In some such examples, the base station 702 may facilitate communication between the gateway 728 and the network node 706. In examples in which the aerial device implements a regenerative payload, the regenerative aerial device may have an on-board base station. In some such examples, the on-board base station may communicate with the network node 706 via the gateway 728. In some examples, the on-board base station may include a DU and a CU, such as the DU 105 and the CU 106 of FIG. 1. In some examples, the on-board base station may include a DU that is in communication with a corresponding CU that is on the ground.

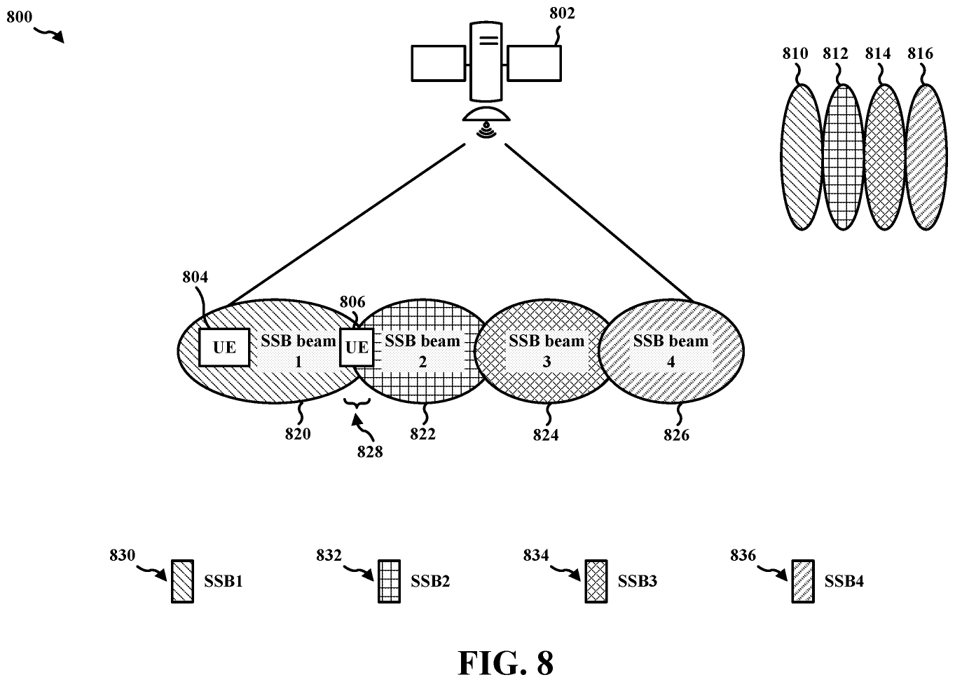

FIG. 8 illustrates an example NTN cell 800 supported by an aerial device 802, as presented herein. As shown in FIG. 8, the NTN cell 800 includes four example beams that are each associated with a respective footprint on the ground surface. For example, a first beam 810 may be associated with a first footprint 820, a second beam 812 may be associated with a second footprint 822, a third beam 814 may be associated with a third footprint 824, and a fourth beam 816 may be associated with a fourth footprint 826.

In the illustrated example of FIG. 8, a first UE 804 and a second UE 806 are each located within a coverage area of the NTN cell 800 and may exchange communications with the aerial device 802. For example, the first UE 804 is located within an area of the first footprint 820 and, thus, may transmit signals to and/or receive signals from the aerial device 802 via the first beam 810. In the example of FIG. 8, the second UE 806 is located within a region that is overlapping with portions of the first footprint 820 and the second footprint 822. In some such examples, the second UE 806 may transmit signals to and/or receive signals from the aerial device 802 via the first beam 810 and/or the second beam 812.

As shown in FIG. 8, the footprints of the NTN cell 800 are generally distinct. Such distinct footprints create opportunities for re-using resources associated with different beams for transmitting the second portion of a RedCap SSB (e.g., the information from the first portion that is copied into adjacent symbols). For example, and referring to the example of FIG. 8, the first footprint 820 associated with the first beam 810 is non-overlapping with the third footprint 824 associated with the third beam 814. Thus, first resources associated with the first beam 810 may include a first SSB (“SSB1”), and third resources associated with the third beam 814 may include a third SSB, and where the first resources and the third resource may at least partially overlap with each other. In such scenarios, since the footprints associated with the respective beams are distinct, concerns related to mutual interference between the first resources and the third resources for the first beam 810 and the third beam 814, respectively, may be reduced and/or negligible. For example, the first UE 804 may not detect a signal transmitted over the third beam 814 and/or the signal transmitted over the third beam 814 may arrive at the first UE 804 with very low strength. In such scenarios, transmission of the third SSB over the third beam 814 will not cause a severe signal deterioration for the first UE 804 to receive the first SSB, though the resources for the two SSBs overlap at least partially.

Aspects disclosed herein provide techniques for utilizing characteristics associated with an NTN to improve reception of SSBs for NTN reduced capability UEs (e.g., UEs with reduced capabilities operating in an NTN). For example, aspects disclosed herein provide techniques for reducing power consumption of a UE with reduced capabilities, for example, by reducing the number of symbols that the UE may monitor to receive a RedCap SSB. Additionally, or alternatively, the techniques disclosed herein may reduce UE complexity, for example, by reducing the number of hypotheses that the UE with reduced capabilities may try when performing decoding of the RedCap SSB.

For purposes of this disclosure, an SSB may be described as containing a first portion and a second portion. The first portion of an SSB may refer to a legacy SSB, as described in connection with the first SSB 500 of FIG. 5A. The second portion of an SSB may refer to the part of the SSB that may not be received by a reduced capability UE, for example, due to the limited operational bandwidth of the reduced capability UE. The second portion may be replicated (e.g., copied) and placed in another time resource to enable the reduced capability UE to receive the full contents of the SSB. For example, the second portion may include PBCH information that is copied into adjacent symbols, as described in connection with the second SSB 520, the third SSB 540, and the fourth SSB 560 of FIG. 5A, FIG. 5B, and FIG. 5C, respectively.

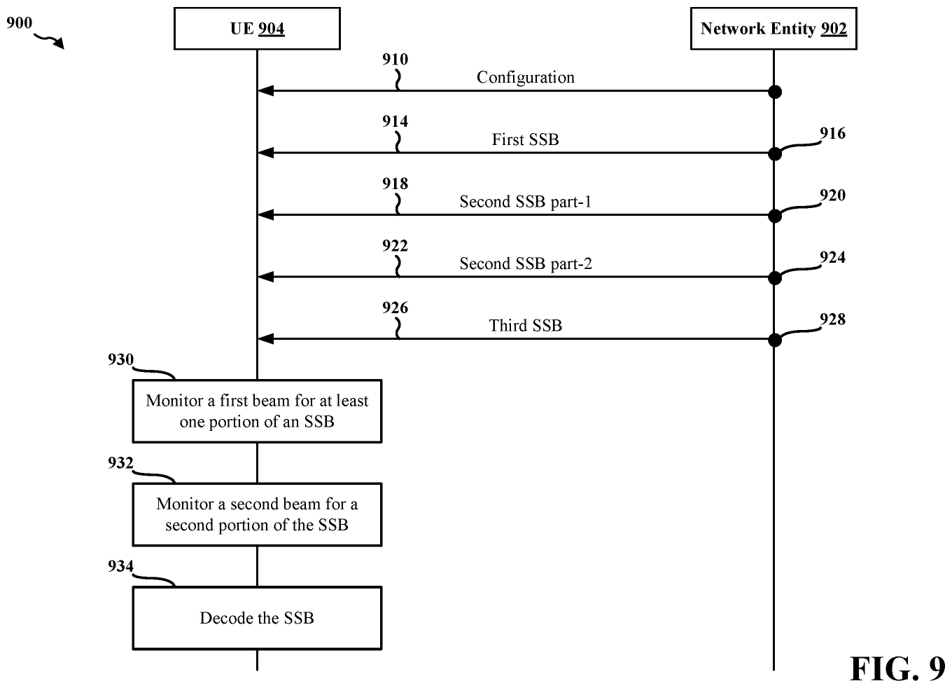

FIG. 9 illustrates an example communication flow 900 between a network entity 902 and a UE 904, as presented herein. One or more aspects described for the network entity 902 may be performed by a component of a base station or a network entity, such as a CU, a DU, and/or an RU. In the illustrated example, the communication flow 900 facilitates the use of RedCap SSBs in an NTN. Aspects of the network entity 902 may be implemented by the base stations 102 of FIG. 1 and/or the base station 410 of FIG. 4. Aspects of the UE 904 may be implemented by the UEs 104 of FIG. 1 and/or the UE 450 of FIG. 4. Although not shown in the illustrated example of FIG. 9, in additional or alternative examples, the network entity 902 and/or the UE 904 may be in communication with one or more other base stations or UEs.

In the example of FIG. 9, the network entity 902 may output a configuration 910 that is obtained (e.g., received) by the UE 904. The configuration 910 may indicate whether the network entity 902 supports RedCap SSBs. In some examples, the configuration 910 may indicate that the second portion of an SSB will precede the first portion of the SSB. In some examples, the configuration 910 may indicate that the second portion of an SSB will follow the first portion of the SSB. In some examples, the configuration 910 may indicate a distance in time between the first portion and the second portion of an SSB. In some examples, the configuration 910 may be (pre)configured at the UE 904, and/or described in a technical specification.

As shown in FIG. 9, the network entity 902 may output multiple SSBs. For example, the network entity 902 may output a first SSB 914 on a first resource 916. The network entity 902 may output a second SSB including a first portion (e.g., a second SSB part-1 918) and a second portion (e.g., a second SSB part-2 922). The network entity 902 may output the second SSB part-1 918 on a second resource 920, and may output the second SSB part-2 922 on a third resource 924. The network entity 902 may also output a third SSB 926 on a fourth resource 928.

The UE 904 may perform a monitoring procedure 930 to monitor a first beam for at least one portion of an SSB. For example, the UE 904 may monitor the first resource 916, the second resource 920, the third resource 924, and/or the fourth resource 928 to receive a portion of an SSB, such as the second SSB part-1 918.

The UE 904 may perform a monitoring procedure 932 to monitor a second beam for a second portion of the SSB. For example, the UE 904 may monitor the first resource 916, the third resource 924, and/or the fourth resource 928 to receive the second SSB part-2 922.

The UE 904 may perform a decoding procedure 934 to decode the SSB. For example, the UE 904 may use the portion of the SSB received, via the monitoring procedure 930, and the second portion of the SSB received, via the monitoring procedure 932, to decode the second SSB.

In some examples, the UE 904 may include a higher capability UE that is configured with the capability to receive an SSB via the first portion of an SSB, such as the second SSB part-1 918.

In some examples, when performing the monitoring procedure 932, the UE 904 may receive the second portion of the second SSB (e.g., the second SSB part-2 922) on a resource that precedes the first portion of the second SSB (e.g., the second SSB part-1 918). For example, the UE 904 may receive the second SSB part-2 922 on a resource that overlaps, at least partially, with the first SSB 914. In other examples, the UE 904 may receive the second portion of the second SSB (e.g., the second SSB part-2 922) on a resource that follows the first portion of the second SSB (e.g., the second SSB part-1 918). For example, the UE 904 may receive the second SSB part-2 922 on a resource that overlaps, at least partially, with the third SSB 926.

In some examples, the second portion from beam m may, at least partially, overlap with the first portion from beam n in the time and/or frequency domains.

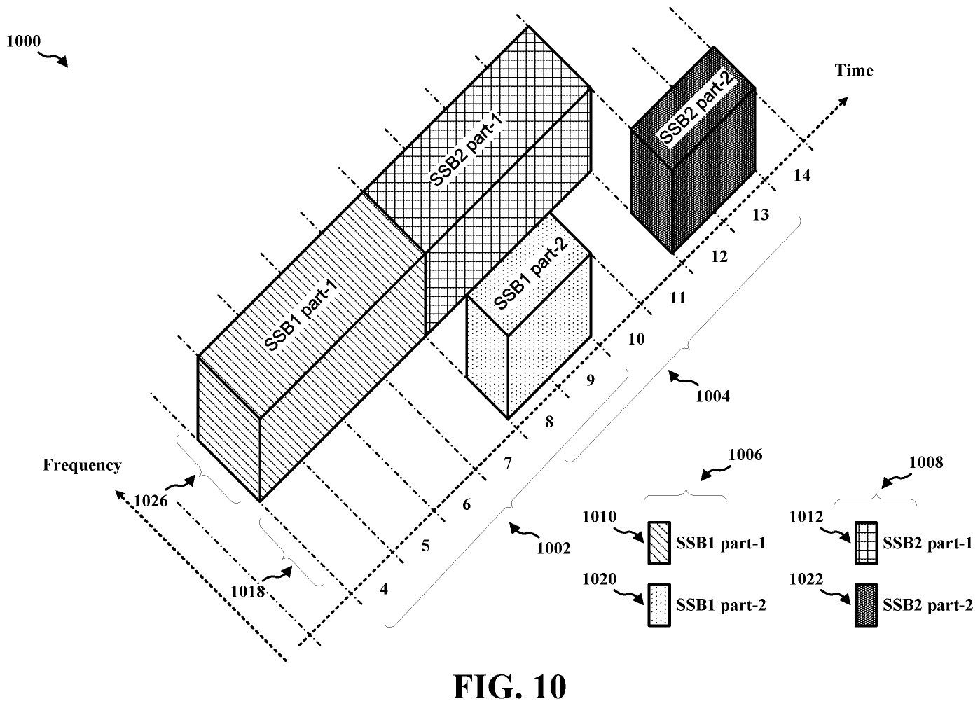

FIG. 10 illustrates a mapping 1000 of a first SSB 1006 and a second SSB 1008 to time and frequency resources, as presented herein. In the illustrated example of FIG. 10, a first beam may be allocated first beam resources 1002 including symbols 4 to 9 in the time domain. Similarly, a second beam may be allocated second beam resources 1004 including symbols 8 to 13 in the time domain. As shown in FIG. 10, the first SSB 1006 includes a first portion 1010 (“SSB1 part-1”) and a second portion 1020 (“SSB1 part-2”). The second portion 1020 may include information of the first portion 1010 that may not be received by a UE, for example, due to a reduced operational bandwidth of the UE. The second SSB 1008 includes a third portion 1012 (“SSB2 part-1”) and a fourth portion 1022 (“SSB2 part-2”). Similar to the second portion 1020, the fourth portion 1022 may include information of the third portion 1012 that may not be received by a UE, for example, due to a reduced operational bandwidth of the UE.

In the illustrated example of FIG. 10, the first portion 1010 and the second portion 1020 of the first SSB 1006 occupy first resources and second resources, respectively, in the time and frequency domains. Similarly, the third portion 1012 and the fourth portion 1022 of the second SSB 1008 occupy third resources and fourth resources, respectively, in the time and frequency domains. As shown in FIG. 10, the first resources and the third resources are adjacent resources in the time domain. For example, the first resources associated with the first portion 1010 occupy symbols 4 to 7 in the time domain and the third resources associated with the third portion 1012 occupy symbols 8 to 11 in the time domain.

In the illustrated example of FIG. 10, the second resources associated with the second portion 1020 of the first SSB 1006 overlap in time, at least partially, with the third resources associated with the second SSB 1008. For example, the third resources occupy symbols 8 to 11 and the second resources occupy symbols 8 and 9 in the time domain. However, the second resources and the third resources are non-overlapping in the frequency domain, as shown in FIG. 10. For example, the second resources associated with the second portion 1020 occupy a first frequency bandwidth 1018, the third resources occupy a second frequency bandwidth 1026, and the first frequency bandwidth 1018 and the second frequency bandwidth 1026 are non-overlapping in the frequency domain.

In other examples, the resources associated with the second portion of a first SSB may overlap in time and frequency with the first portion of a second SSB part.

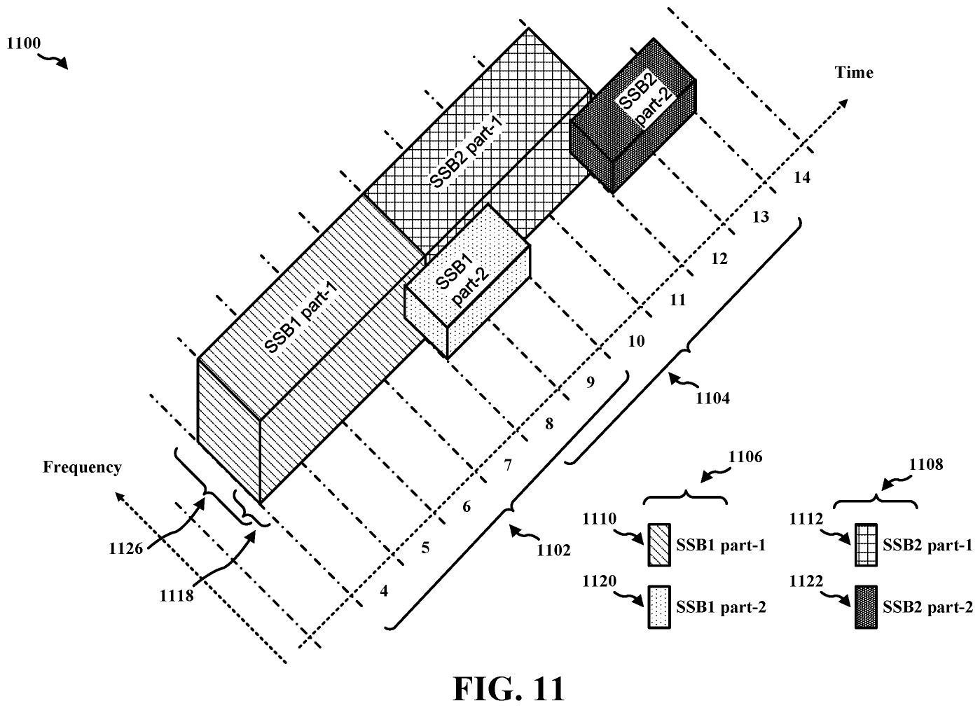

FIG. 11 illustrates a mapping 1100 of a first SSB 1106 and a second SSB 1108 to time and frequency resources, as presented herein. In the illustrated example of FIG. 11, a first beam may be allocated first beam resources 1102 including symbols 4 to 9 in the time domain. Similarly, a second beam may be allocated second beam resources 1104 including symbols 8 to 13 in the time domain. As shown in FIG. 11, the first SSB 1106 includes a first portion 1110 (“SSB1 part-1”) and a second portion 1120 (“SSB1 part-2”). The second portion 1120 may include information of the first portion 1110 that may not be received by a UE, for example, due to a reduced operational bandwidth of the UE. The second SSB 1108 includes a third portion 1112 (“SSB2 part-1”) and a fourth portion 1122 (“SSB2 part-2”). Similar to the second portion 1120, the fourth portion 1122 may include information of the third portion 1112 that may not be received by a UE, for example, due to a reduced operational bandwidth of the UE.

In the illustrated example of FIG. 11, the first portion 1110 and the second portion 1120 of the first SSB 1106 occupy first resources and second resources, respectively, in the time and frequency domains. Similarly, the third portion 1112 and the fourth portion 1122 of the second SSB 1108 occupy third resources and fourth resources, respectively, in the time and frequency domains. Similar to the example of FIG. 10, the first resources and the third resources are adjacent resources in the time domain. For example, the first resources occupy symbols 4 to 7 in the time domain and the third resources occupy symbols 8 to 11 in the time domain.

In the illustrated example of FIG. 11, the second resources associated with the second portion 1120 of the first SSB 1106 overlap, at least partially, in time with the third resources associated with the second SSB 1108. For example, the third resources occupy symbols 8 to 11 in the time domain and the second resources occupy symbols 8 and 9 in the time domain. Additionally, the second resources and the third resources are at least partially overlapping in the frequency domain, as shown in FIG. 11. For example, the second resources occupy a first frequency bandwidth 1118, the third resources occupy a second frequency bandwidth 1126, and the first frequency bandwidth 1118 and the second frequency bandwidth 1126 are at least partially overlapping in the frequency domain.

In the illustrated examples of FIG. 10 and FIG. 11, the second portion of an SSB follows (or succeeds) the first portion of the SSB in the time domain. For example, and referring to the example of FIG. 10, the first resources associated with the first portion 1010 occupy symbols 4 to 7, and the second resources associated with the second portion 1020 occupy symbols 8 and 9. Similarly, in the example of FIG. 11, the first resources associated with the first portion 1110 occupy symbols 4 to 7, and the second resources associated with the second portion 1120 occupy symbols 8 and 9. In some examples, the same rule, e.g., the second portion of an SSB follows (or succeeds) the first portion of the SSB in the time domain, applies for all of the SSBs. Thus, a UE, such as a reduced capability UE, searching for the second portion of an SSB may reduce the number of hypotheses it tries to one as it can skip searching for the second portion of the SSB in resources preceding the first portion of the SSB. As described above, reducing the number of hypotheses that a UE tries may reduce UE complexity.

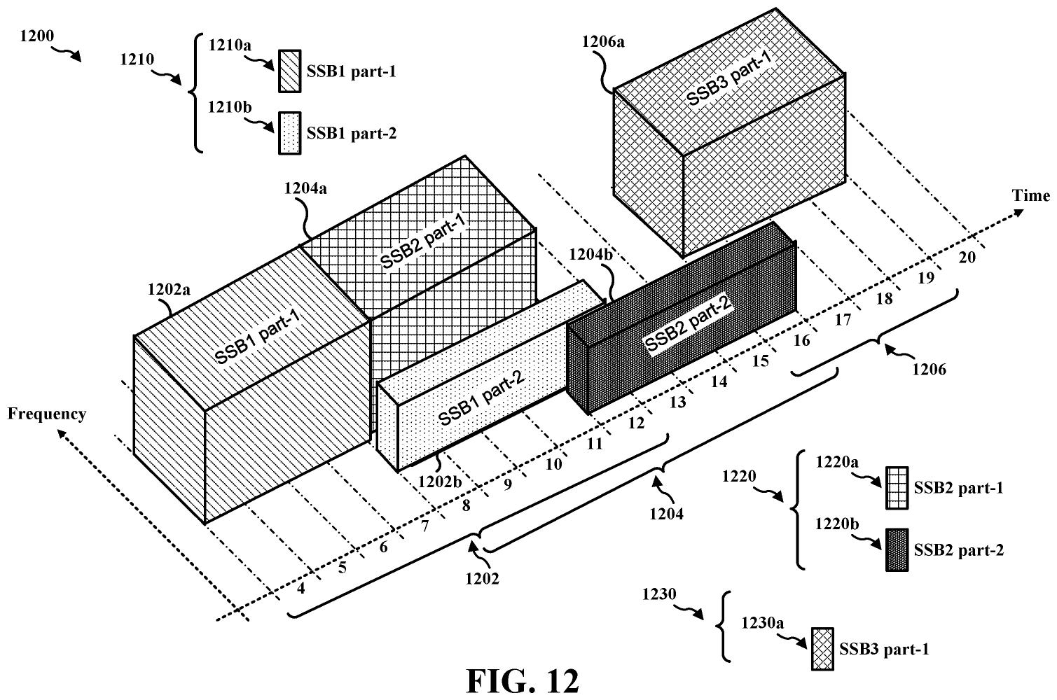

In some examples, the second portion of a first SSB may overlap with the first portion and the second portion of a second SSB. For example, FIG. 12 illustrates a mapping 1200 of a first SSB 1210, a second SSB 1220, and a third SSB 1230 to time and frequency resources, as presented herein. In the illustrated example of FIG. 12, a first beam may be allocated first beam resources 1202 including symbols 4 to 12 in the time domain. Similarly, a second beam may be allocated second beam resources 1204 including symbols 8 to 16 in the time domain, and a third beam may be allocated third beam resources 1206 including symbols 16 to 19 in the time domain. As shown in FIG. 12, the first SSB 1210 includes a first portion 1210a (“SSB1 part-1”) and a second portion 1210b (“SSB1 part-2”). The second portion 1210b may include information of the first portion 1210a that may not be received by a UE, for example, due to a reduced operational bandwidth of the UE. The second SSB 1220 includes a third portion 1220a (“SSB2 part-1”) and a fourth portion 1220b (“SSB2 part-2”). Similar to the second portion 1210b of the first SSB 1210, the fourth portion 1220b may include information of the third portion 1220a that may not be received by a UE, for example, due to a reduced operational bandwidth of the UE. In the example of FIG. 12, the third SSB 1230 may correspond to a fifth portion 1230a (“SSB3 part-1”). Although not shown in the example of FIG. 12, it may be appreciated that the third SSB 1230 may include a second portion (e.g., an “SSB3 part-2”) that is not shown for simplicity.

In the illustrated example of FIG. 12, the first portion 1210a and the second portion 1210b of the first SSB 1210 occupy a first resources subset 1202a and a second resources subset 1202b, respectively, of the first beam resources 1202 in the time and frequency domains. Similarly, the third portion 1220a and the fourth portion 1220b of the second SSB 1220 occupy a third resources subset 1204a and a fourth resources subset 1204b, respectively, of the second beam resources 1204 in the time and frequency domains. Additionally, the third SSB 1230 occupies a fifth resources subset 1206a of the third beam resources 1206 in the time and frequency domains. As shown in FIG. 12, the first resources subset 1202a and the third resources subset 1204a are adjacent resources in the time domain. For example, the first resources subset 1202a occupies symbols 4 to 7 in the time domain and the third resources subset 1204a occupies symbols 8 to 11 in the time domain.

In some examples, a length in time associated with a second portion of a first SSB may be longer than the distance in time between a first portion of the first SSB and a first portion of a second SSB. For example, in the illustrated example of FIG. 12, the second resources subset 1202b associated with the second portion 1210b of the first SSB 1210 is allocated a smaller frequency bandwidth than the resources allocated to the second portion 1020 of FIG. 10 and/or to the second portion 1120 of FIG. 11. In some such scenarios, the second resources subset 1202b may be allocated more resources in the time domain. For example, the second resources subset 1202b of FIG. 12 are allocated five resources in the time domain (e.g., symbols 8 to 12) compared to two resources in the time domain (e.g., symbols 8 and 9) in the examples of FIG. 10 and FIG. 11.

As shown in FIG. 12, the second resources subset 1202b associated with the second portion 1210b of the first SSB 1210 at least partially overlaps in time with at least a portion of the third resources subset 1204a and the fourth resources subset 1204b associated with the second SSB 1220. For example, the third resources subset 1204a occupies symbols 8 to 11 and the fourth resources subset 1204b occupies symbols 12 to 16 in the time domain. Thus, in this example, the second portion 1210b of the first SSB 1210 at least partially overlaps in time with the third portion 1220a and the fourth portion 1220b associated with the second SSB 1220.

In the illustrated example of FIG. 12, the fourth resources subset 1204b allocated to the fourth portion 1220b of the second SSB 1220 at least partially overlaps with the fifth resources subset 1206a allocated to the third SSB 1230. As described above, the third SSB 1230 may include a first portion (e.g., an “SSB3 part-1”). Thus, the fourth resources subset 1204b associated with the fourth portion 1220b may overlap, at least partially, with the fifth resources subset 1206a associated with the fifth portion 1230a of the third SSB 1230.

Although the example of FIG. 12 illustrates resources overlapping in the time domain, as described in connection with the example of FIG. 10, in other examples, the resources associated with the respective portions of the first SSB 1210, the second SSB 1220, and/or the third SSB 1230 may overlap, at least partially, in the time and frequency domains, as described in connection with the example of FIG. 11.

Similar to the examples of FIG. 10 and FIG. 11, in the illustrated example of FIG. 12, the second portion (e.g., an SSB part-2) of an SSB follows (or succeeds) the first portion of the SSB in the time domain. For example, the first resources subset 1202a associated with the first portion 1210a occupies symbols 4 to 7, and the second resources subset 1202b associated with the second portion 1210b occupies symbols 8 to 12. Thus, a UE, such as a reduced capability UE, searching for the second portion 1210b of the first SSB 1210 may reduce the number of hypotheses it tries to one as the UE can skip searching for the second portion 1210b in resources preceding the first portion 1210a in the time domain. As described above, reducing the number of hypotheses that a UE tries when performing decoding of an SSB may reduce UE complexity.

In the illustrated examples of FIG. 10, FIG. 11, and FIG. 12, the SSB indexes are consecutive and the beams transmitting the respective SSBs are neighboring beams For example, and referring to the example of FIG. 8, the first beam 810 may transmit a first SSB 830 (“SSB1” or “SSB Beam 1”), the second beam 812 may transmit a second SSB 832 (“SSB2” or “SSB Beam 2”), the third beam 814 may transmit a third SSB 834 (“SSB 3” or “SSB Beam 3”), and the fourth beam 816 may transmit a fourth SSB 836 (“SSB4” or “SSB Beam 4”).

Although NTN beams are associated with relatively distinct footprints on the ground, there are scenarios in which some overlap may occur. For example, and referring again to the example of FIG. 8, a region 828 represents an area that overlaps between the first footprint 820 and the second footprint 822. In such a scenario, a UE located in the region 828 (e.g., the second UE 806) may receive two beams (e.g., the first beam 810 and the second beam 812), which may result in overlapping SSB beams.

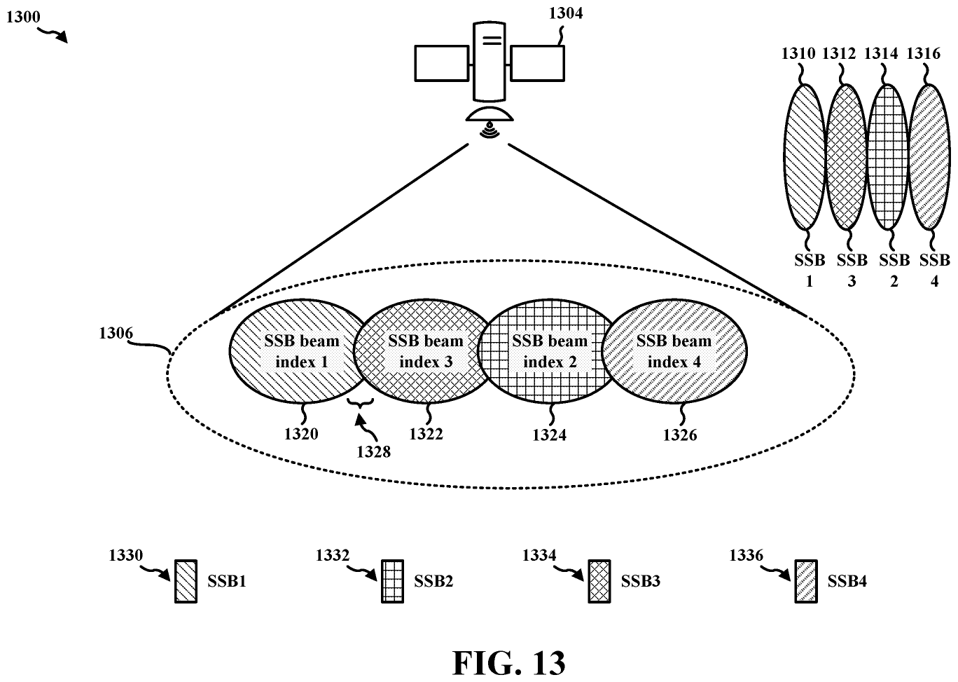

In some examples, consecutive SSB indexes may be associated with beams that are covering non-neighboring areas. For example, FIG. 13 illustrates a diagram 1300 including an aerial device 1304 providing service coverage to an NTN cell 1306, as presented herein. Although not shown in the example of FIG. 13, the aerial device 1304 may be in wireless communication with a UE on the ground via a service link, and may be in wireless communication with a ground node via a feeder link, as described in connection with FIG. 7.

As shown in FIG. 13, the NTN cell 1306 includes four example beams that are each associated with a respective footprint on the ground surface. For example, a first beam 1310 may be associated with a first footprint 1320, a second beam 1312 may be associated with a second footprint 1322, a third beam 1314 may be associated with a third footprint 1324, and a fourth beam 1316 may be associated with a fourth footprint 1326. Additionally, each of the beams may transmit a respective SSB.

In some examples, the network may transmit SSBs with consecutive SSB indexes using beams (e.g., a beam m and a beam n) that serve non-neighboring areas. For example, in the example of FIG. 13, consecutive SSB indexes are associated with beams covering non-neighboring areas. For example, the first beam 1310 may transmit a first SSB 1330 (“SSB1” or “SSB beam index 1”) and the third beam 1314 may transmit a second SSB 1332 (“SSB2” or “SSB beam index 2”). As shown in FIG. 13, the first footprint 1320 associated with the first beam 1310 and the third footprint 1324 associated with the third beam 1314 are non-neighboring. Similarly, the second beam 1312 may transmit a third SSB 1334 (“SSB3” or “SSB beam index 3”) and the fourth beam 1316 may transmit a fourth SSB 1336 (“SSB4” or “SSB beam index 4”). As shown in FIG. 13, the second footprint 1322 associated with the second beam 1312 and the fourth footprint 1326 associated with the fourth beam 1316 are non-neighboring.

In the illustrated example of FIG. 13, although there may be overlap between portions of the footprints, the SSB indexes that are consecutive are associated with non-neighboring beams, which reduces the likelihood of interference with respect to the SSB beams. For example, a UE may be located in a region 1328 that is overlapping between the first beam 1310 and the second beam 1312. In the example of FIG. 13, the second beam 1312 is transmitting the third SSB 1334 and, thus, will not interference with the first SSB 1330 being transmitted by the first beam 1310.

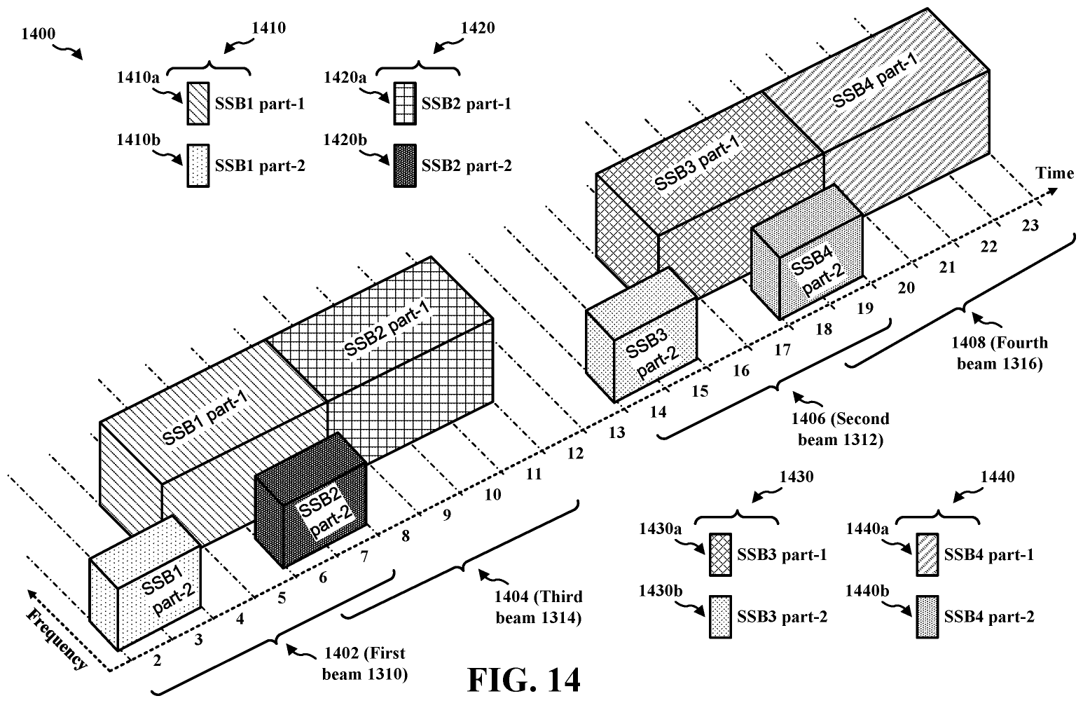

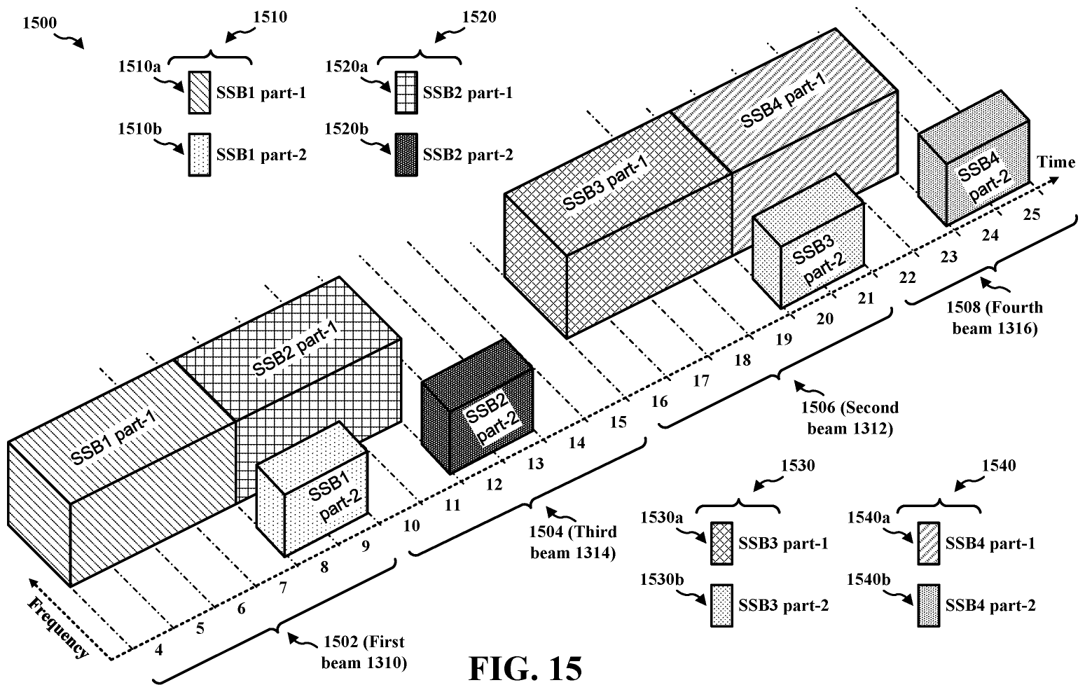

In some examples in which beams serving non-neighboring areas transmit consecutive SSB indexes, the second portion of an SSB (e.g., an SSB part-2) may be allocated resources preceding the first portion of the SSB (e.g., an SSB part-1), as described in connection with FIG. 14. In other examples, the second portion of an SSB may be allocated resources following the first portion of the SSB, as described in connection with FIG. 15.

FIG. 14 depicts a diagram 1400 illustrating an example of mapping SSBs to resources in which consecutive SSB indexes are associated with beams covering non-neighboring areas, as presented herein. In the illustrated example of FIG. 14, four example SSBs are mapped to resources in the time and frequency domains for four different beams. For example, first beam resources 1402 may be associated with a first beam, such as the first beam 1310 of FIG. 13. As described in the example of FIG. 13, consecutive SSB indexes are associated with non-neighboring beams. For example, second beam resources 1404 may be associated with a second beam that is non-neighboring to the first beam. In the example of FIG. 14, the second beam resources 1404 are allocated to the third beam 1314 of FIG. 13. In a similar manner, third beam resources 1406 are allocated to the second beam 1312 of FIG. 13, and fourth beam resources 1408 are allocated to the fourth beam 1316 of FIG. 13.

In the illustrated example of FIG. 14, the second portion of an SSB is preceding the first portion of the respective SSB. For example, a first portion 1410a (“SSB1 part-1”) of a first SSB 1410 starts at symbol 4, and a second portion 1410b of the first SSB 1410 (“SSB1 part-2”) starts at symbol 2. A third portion 1420a of a second SSB 1420 (“SSB2 part-1”) starts at symbol 8, and a fourth portion 1420b of the second SSB 1420 (“SSB2 part-2”) starts at symbol 6. In a similar manner, a fifth portion 1430a of a third SSB 1430 (“SSB3 part-1”) starts at symbol 16, and a sixth portion 1430b of the third SSB 1430 (“SSB3 part-2”) starts at symbol 14. Additionally, a seventh portion 1440a of a fourth SSB 1440 (“SSB4 part-1”) starts at symbol 20, and an eighth portion 1440b of the fourth SSB 1440 (“SSB4 part-2”) starts at symbol 18.

In the example of FIG. 14, although portions of the second SSB 1420 are overlapping with the first beam resources 1402 associated with the first SSB 1410, the beam carrying the fourth portion 1420b is geographically separate from the beam carrying the first portion 1410a and, thus, interference between the first SSB 1410 and the second SSB 1420 may be limited. For example, the second beam resources 1404 are allocated to the third beam 1314 of FIG. 13, which has a footprint that is non-geographically overlapping with the first footprint 1320 associated with the first beam 1310 of FIG. 13.

In the illustrated example of FIG. 14, the second portion of an SSB is preceding the respective first portion of the SSB. FIG. 15 depicts a diagram 1500 illustrating an example of mapping SSBs to resources in which consecutive SSB indexes are associated with beams covering non-neighboring areas, as presented herein. In the illustrated example of FIG. 15, the second portion of an SSB is following the respective first portion of the SSB. The mapping of resources of FIG. 15 to SSBs and beams may be similar to the examples of FIG. 13 and FIG. 14.

For example, first beam resources 1502 may be associated with a first beam, such as the first beam 1310 of FIG. 13. In the example of FIG. 15, second beam resources 1504 may be allocated to the third beam 1314 of FIG. 13. In a similar manner, third beam resources 1506 are allocated to the second beam 1312 of FIG. 13, and fourth beam resources 1508 are allocated to the fourth beam 1316 of FIG. 13.

In the illustrated example of FIG. 15, the second portion of an SSB is following the first portion of the respective SSB. For example, a first portion 1510a of a first SSB 1510 (“SSB1 part-1”) starts at symbol 4, and a second portion 1510b of the first SSB 1510 (“SSB1 part-2”) starts at symbol 8. A third portion 1520a of a second SSB 1520 (“SSB2 part-1”) starts at symbol 8, and a fourth portion 1520b of the second SSB 1520 (“SSB2 part-2”) starts at symbol 12. In a similar manner, a fifth portion 1530a of a third SSB 1530 (“SSB3 part-1”) starts at symbol 16, and a sixth portion 1530b of the third SSB 1530 (“SSB3 part-2”) starts at symbol 20. Additionally, a seventh portion 1540a of a fourth SSB 1540 (“SSB4 part-1”) starts at symbol 20, and an eighth portion 1540b of the fourth SSB 1540 (“SSB4 part-2”) starts at symbol 24.

As shown in FIG. 15, consecutive SSB indexes are being transmitted by non-neighboring beams. For example, the first SSB 1510 is being transmitted by the first beam 1310 of FIG. 13 and the second SSB 1520 is being transmitted by the third beam 1314 of FIG. 13. Similarly, the third SSB 1530 is being transmitted by the second beam 1312 of FIG. 13, and the fourth SSB 1540 is being transmitted by the fourth beam 1316 of FIG. 13.

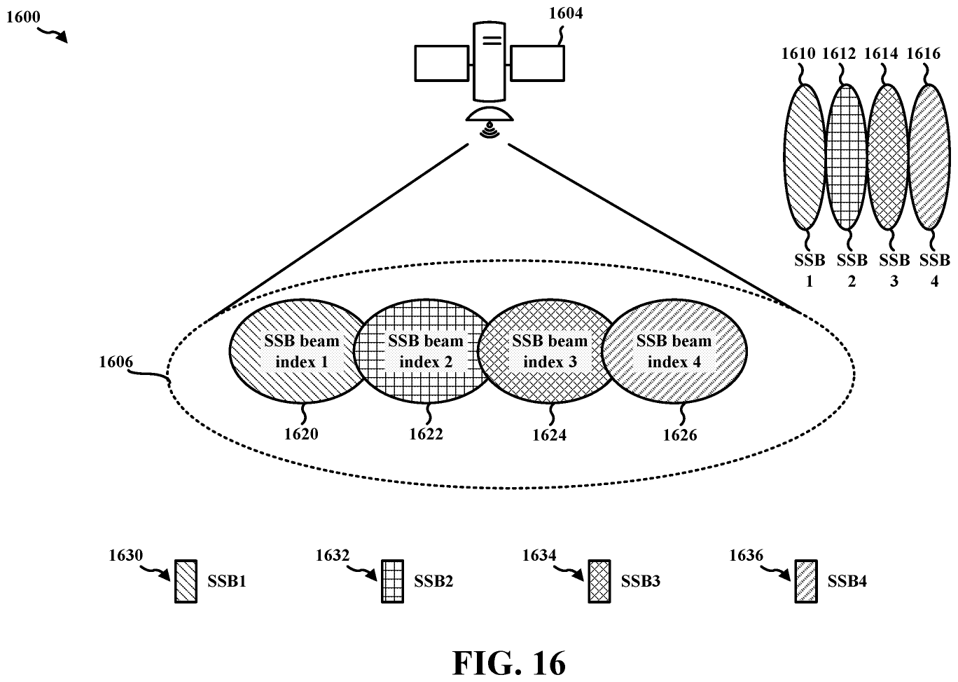

In some examples, the network may use beams with consecutive SSB indexes to serve two neighboring areas. For example, FIG. 16 illustrates a diagram 1600 including an aerial device 1604 providing service coverage to an NTN cell 1606, as presented herein. Although not shown in the example of FIG. 16, the aerial device 1604 may be in wireless communication with a UE on the ground via a service link, and may be in wireless communication with a ground node via a feeder link, as described in connection with FIG. 7.

As shown in FIG. 16, the NTN cell 1606 includes four example beams that are each associated with a respective footprint on the ground surface. For example, a first beam 1610 may be associated with a first footprint 1620, a second beam 1612 may be associated with a second footprint 1622, a third beam 1614 may be associated with a third footprint 1624, and a fourth beam 1616 may be associated with a fourth footprint 1626. Additionally, each of the beams may transmit a respective SSB.

In the example of FIG. 16, the aerial device 1604 may output a first SSB 1630 (“SSB1” or “SSB beam index 1”) on the first beam 1610, may output a second SSB 1632 (“SSB2” or “SSB beam index 2”) on the second beam 1612, may output a third SSB 1634 (“SSB3” or “SSB beam index 3”) on the third beam 1614, and may output a fourth SSB 1636 (“SSB4” or “SSB beam index 4”) on the fourth beam 1616.

In some examples, the network may transmit SSBs with consecutive SSB indexes to serve two neighboring areas, but the indexes of beam m and beam n may be non-consecutive. For example, the network may output a first portion of a first SSB (e.g., an SSB1 part-1) on a beam m, and may output a second portion of the first SSB (e.g., an SSB1 part-2) on a beam n that is not consecutive to beam m. That is, if beam m indexes to beam 3, then beam n will index to a beam that is not consecutive to beam 3. For example, beam n may index to beam 1 or may index to beam 5, but will not index to beam 2 or to beam 4.

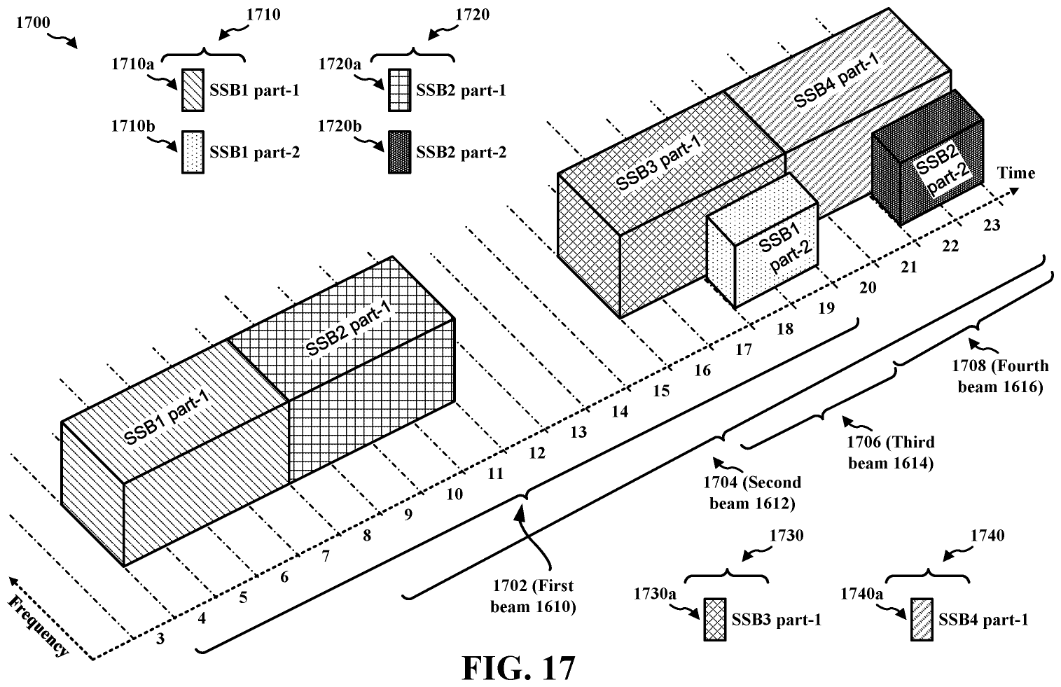

FIG. 17 depicts a diagram 1700 illustrating an example of mapping SSBs to resources in which consecutive SSB indexes are associated with beams covering non-neighboring areas, as presented herein.

In the illustrated example of FIG. 17, four example SSBs are mapped to resources in the time and frequency domains for four different beams. For example, first beam resources 1702 may be associated with a first beam, such as the first beam 1610 of FIG. 16, second beam resources 1704 may be associated with a second beam, such as the second beam 1612 of FIG. 16, third beam resources 1706 may be associated with a third beam, such as the third beam 1614 of FIG. 16, and fourth beam resources 1708 may be associated with a fourth beam, such as the fourth beam 1616 of FIG. 16.

In the illustrated example of FIG. 17, a second portion of an SSB (e.g., an SSB part-2) is following the corresponding first portion of the SSB (e.g., an SSB part-1). For example, a first portion 1710a of a first SSB 1710 (“SSB1 part-1”) starts at symbol 4, and a second portion 1710b of the first SSB 1710 (“SSB1 part-2”) starts at symbol 18. A third portion 1720a of a second SSB 1720 (“SSB2 part-1”) starts at symbol 8, and a fourth portion 1720b of the second SSB 1720 (“SSB2 part-2”) starts at symbol 22. As shown in FIG. 17, a fifth portion 1730a of a third SSB 1730 (“SSB3 part-1”) starts at symbol 16, and sixth portion 1740a of a fourth SSB 1740 (“SSB4 part-1”) starts at symbol 20. In the example of FIG. 17, the second portions of the third SSB 1730 and the fourth SSB 1740 are not shown for convenience.

As shown in FIG. 17, resources carrying the second portion 1710b of the first SSB 1710 associated with the first beam are overlapping with resources carrying the fifth portion 1730a of the third SSB 1730 associated with the third beam (e.g., the third beam 1614 of FIG. 16). Thus, there would be limited mutual interference, with respect to the respective portions of the first SSB 1710 and the third SSB 1730, for a UE located in a region overlapping between the first beam 1610 and the second beam 1612 of FIG. 16. Similarly, resources carrying the fourth portion 1720b of the second SSB 1720 are overlapping with resources carrying the sixth portion 1740a of the fourth SSB 1740 associated with the fourth beam (e.g., the fourth beam 1616 of FIG. 16).

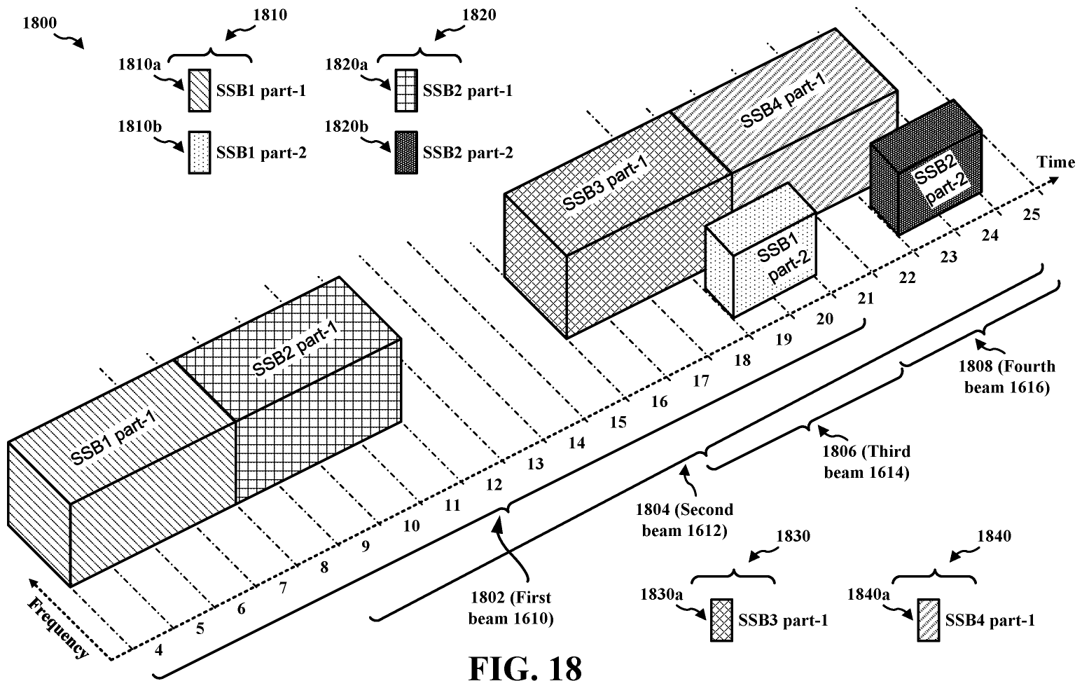

FIG. 18 depicts a diagram 1800 illustrating another example of mapping SSBs to resources in which consecutive SSB indexes are associated with beams covering non-neighboring areas, as presented herein. In the illustrated example of FIG. 18, four example SSBs are mapped to resources in the time and frequency domains for four different beams. For example, first beam resources 1802 may be associated with a first beam, such as the first beam 1610 of FIG. 16, second beam resources 1804 may be associated with a second beam, such as the second beam 1612 of FIG. 16, third beam resources 1806 may be associated with a third beam, such as the third beam 1614 of FIG. 16, and fourth beam resources 1808 may be associated with a fourth beam, such as the fourth beam 1616 of FIG. 16.

In the illustrated example of FIG. 18, the second portion of an SSB is following the first portion of the SSB in the time domain. For example, a first portion 1810a of a first SSB 1810 (“SSB1 part-1”) starts at symbol 4, and a second portion 1810b of the first SSB 1810 (“SSB1 part-2”) starts at symbol 19. A third portion 1820a of a second SSB 1820 (“SSB2 part-1”) starts at symbol 8, and a fourth portion 1820b of the second SSB 1820 (“SSB2 part-2”) starts at symbol 23. As shown in FIG. 18, a fifth portion 1830a of a third SSB 1830 (“SSB3 part-1”) starts at symbol 16, and a sixth portion 1840a of a fourth SSB 1840 (“SSB4 part-1”) starts at symbol 20. In the example of FIG. 18, the second portions of the third SSB 1830 and the fourth SSB 1840 are not shown for convenience.

As shown in FIG. 18, resources carrying the second portion 1810b of the first SSB 1810 are overlapping with resources carrying the fifth portion 1830a of the third SSB 1830 associated with the third beam (e.g., the third beam 1614 of FIG. 16) as well as with resources carrying the sixth portion 1840a of the fourth SSB 1840 associated with the fourth beam (e.g., the fourth beam 1616 of FIG. 16). Thus, there would be limited mutual interference, with respect to the portions of the first SSB 1810 from the third SSB 1830 and the fourth SSB 1840, for a UE located in a region overlapping between the first beam 1610 and the second beam 1612 of FIG. 16. Similarly, resources carrying the fourth portion 1820b of the second SSB 1820 are associated with the fourth beam (e.g., the fourth beam 1616 of FIG. 16).

In the illustrated example of FIG. 17, the second portion 1710b (e.g., located at symbols 18 and 19) is overlapping with the fifth portion 1730a of the third SSB 1730 (e.g., located at symbols 16 to 19). In the illustrated example of FIG. 18, the second portion 1810b of the first SSB 1810 (e.g., located at symbols 19 and 20) is overlapping with the fifth portion 1830a of the third SSB 1830 (e.g., located at symbols 16 to 19) and with the sixth portion 1840a of the fourth SSB 1840 (e.g., located at symbols 20 to 23).

In the examples of FIGS. 10 to 12, FIG. 14, and FIG. 15, a reduced capability UE monitoring for SSBs may be monitoring more symbols than a higher capability UE. For example, a higher capability UE may monitor 16 symbols to receive four SSBs, such as symbols 4, 8, 16, and 20. However, in some of the above examples, a reduced capability UE may monitor symbols preceding the first SSB (e.g., before symbol 4 in time) or preceding the third SSB (e.g., before symbol 16 in time). In other examples, the reduced capability UE may monitor symbols following the second SSB (e.g., after symbol 11 in time) or following the fourth SSB (e.g., after symbol 23 in time).

In some examples, aspects disclosed herein may apply techniques to minimize the monitoring time of a UE (e.g., a UE with reduced capabilities). For example, the network may transmit the second portion of an SSB to overlap with the first portion from another beam. For example, the network may transmit a first SSB on a first beam and a second SSB beam on a second beam. In such scenarios, resources allocated to the first beam may include a first portion and a second portion for the first SSB. Additionally, resources allocated to the second beam may include a third portion and a fourth portion for the second SSB.

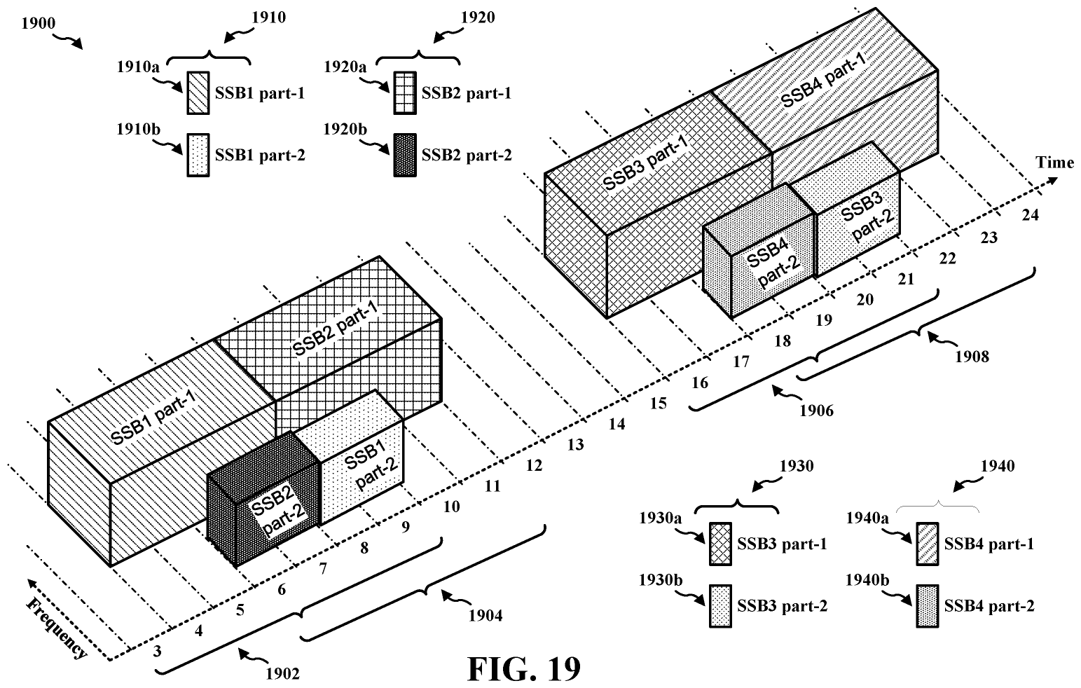

FIG. 19 depicts a diagram 1900 illustrating an example of mapping SSBs to resources while minimizing UE monitoring time, as presented herein. In the illustrated example of FIG. 19, four example SSBs are mapped to resources in the time and frequency domains for four different beams. For example, first beam resources 1902 may be associated with a first beam, second beam resources 1904 may be associated with a second beam, third beam resources 1906 may be associated with a third beam, and fourth beam resources 1908 may be associated with a fourth beam. The beams may be non-neighboring beams, such as in the example of FIG. 13, or may be neighboring beams, such as in the example of FIG. 16.

In the illustrated example of FIG. 19, the second portion of certain SSBs are following the first portion of the respective SSB, while the second portion of other SSBs are preceding the first portion of the respective SSB. For example, a first portion 1910a of a first SSB 1910 (“SSB1 part-1”) starts at symbol 4, and a second portion 1910b of the first SSB 1910 (“SSB1 part-2”) starts at symbol 8, which is following the first portion 1910a of the first SSB 1910. A third portion 1920a of a second SSB 1920 (“SSB2 part-1”) starts at symbol 8, and a fourth portion 1920b of the second SSB 1920 (“SSB2 part-2”) starts at symbol 6, which is preceding the third portion 1920a of the second SSB 1920. Similarly, a fifth portion 1930a of a third SSB 1930 (“SSB3 part-1”) starts at symbol 16, and a sixth portion 1930b of the third SSB 1930 (“SSB3 part-2”) stars at symbol 20, which is following the fifth portion 1930a of the third SSB 1930. A seventh portion 1940a of a fourth SSB 1940 (“SSB4 part-1) starts at symbol 20, and an eighth portion 1940b of the fourth SSB 1940 (“SSB4 part-2”) starts at symbol 18, which is preceding the seventh portion 1940a of the fourth SSB 1940.

As shown in FIG. 19, resources that a UE may monitor to receive an SSB may be reduced to the original 16 symbols that a higher capability UE may monitor when receiving an SSB. Thus, it may be appreciated that the example of FIG. 19 facilitates reducing the UE monitoring time for receiving SSBs, which may reduce power consumption of the UE.

In the illustrated example of FIG. 19, the second portion of an SSB is allocated to resources that are consecutive in time. For example, the second portion 1910b occupies symbols 8 and 9. In other examples, the second portion of an SSB may be allocated resources that are discontinuous in time.

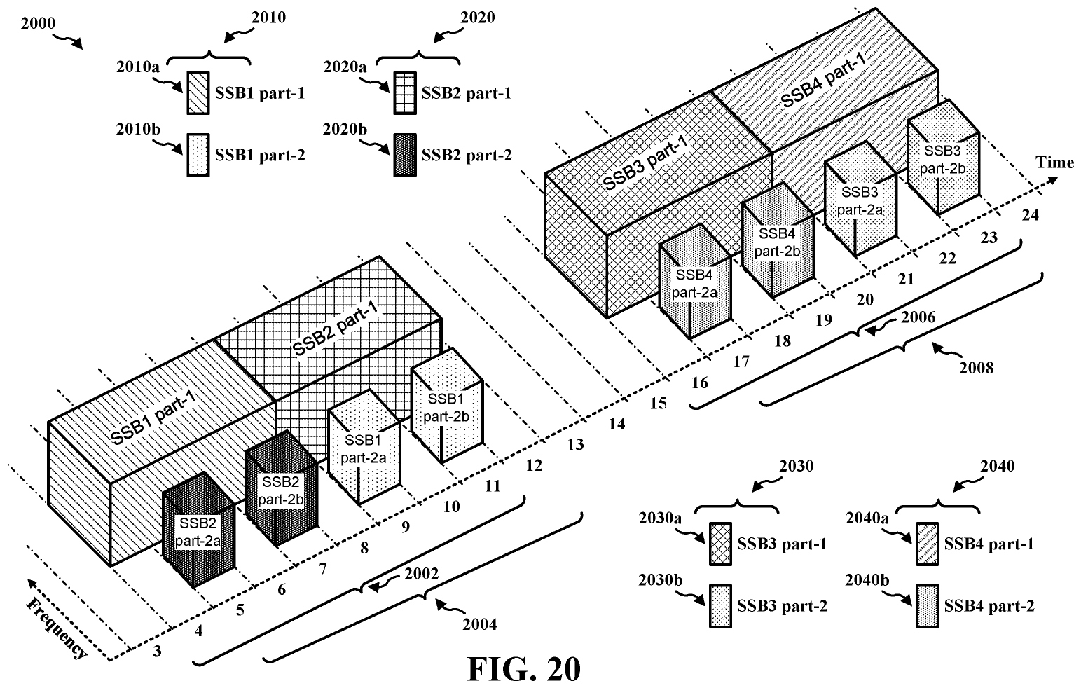

FIG. 20 depicts a diagram 2000 illustrating another example of mapping SSBs to resources while minimizing UE monitoring time, as presented herein. In the illustrated example of FIG. 20, four example SSBs are mapped to resources in the time and frequency domains for four different beams. For example, first beam resources 2002 may be associated with a first beam, second beam resources 2004 may be associated with a second beam, third beam resources 2006 may be associated with a third beam, and fourth beam resources 2008 may be associated with a fourth beam. The beams may be non-neighboring beams, such as in the example of FIG. 13, or may be neighboring beam, such as in the example of FIG. 16.

In the illustrated example of FIG. 20, the second portion of certain SSBs are following the first portion of the respective SSB, while the second portion of other SSBs are preceding the first portion of the respective SSB, as described in the example of FIG. 19. Additionally, the resources allocated to the second portion of an SSB may be discontinuous in time.

For example, a first portion 2010a of a first SSB 2010 (“SSB1 part-1”) starts at symbol 4, and a second portion 2010b of the first SSB 2010 (“SSB1 part-2”) is located at symbols 9 and 11, which are following the first portion 2010a of the first SSB 2010.

A third portion 2020a of a second SSB 2020 (“SSB2 part-1”) starts at symbol 8, and a fourth portion 2020b of the second SSB 2020 (“SSB2 part-2”) is located at symbols 5 and 7, which are preceding the third portion 2020a of the second SSB 2020.

Similarly, a fifth portion 2030a of a third SSB 2030 (“SSB3 part-1”) starts at symbol 16, and a sixth portion 2030b of the third SSB 2030 (“SSB3 part-2”) is located at symbols 21 and 23, which is following the fifth portion 2030a of the third SSB 2030.

Additionally, a seventh portion 2040a of a fourth SSB 2040 (“SSB4 part-1”) starts at symbol 20, and an eighth portion 2040b of the fourth SSB 2040 (“SSB4 part-2”) is located at symbols 17 and 19, which are preceding the seventh portion 2040a of the fourth SSB 2040.

As shown in FIG. 20, the resources that a UE may monitor to receive an SSB may be reduced to the original 16 symbols that a higher capability UE may monitor when receiving an SSB. Thus, it may be appreciated that the example of FIG. 20 facilitates reducing the UE monitoring time for receiving SSBs, which may reduce power consumption of the UE.

Although the example of FIG. 20 illustrates the second portion of an SSB being allocated to resources that are discontinuous in time, it may be appreciated that the second portion of the examples described herein in the other figures may also be allocated to resources that are discontinuous in time.

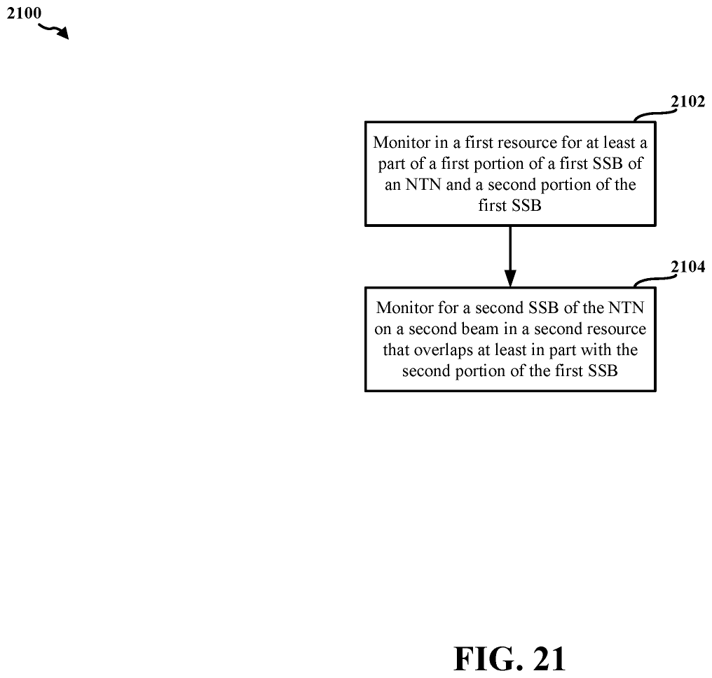

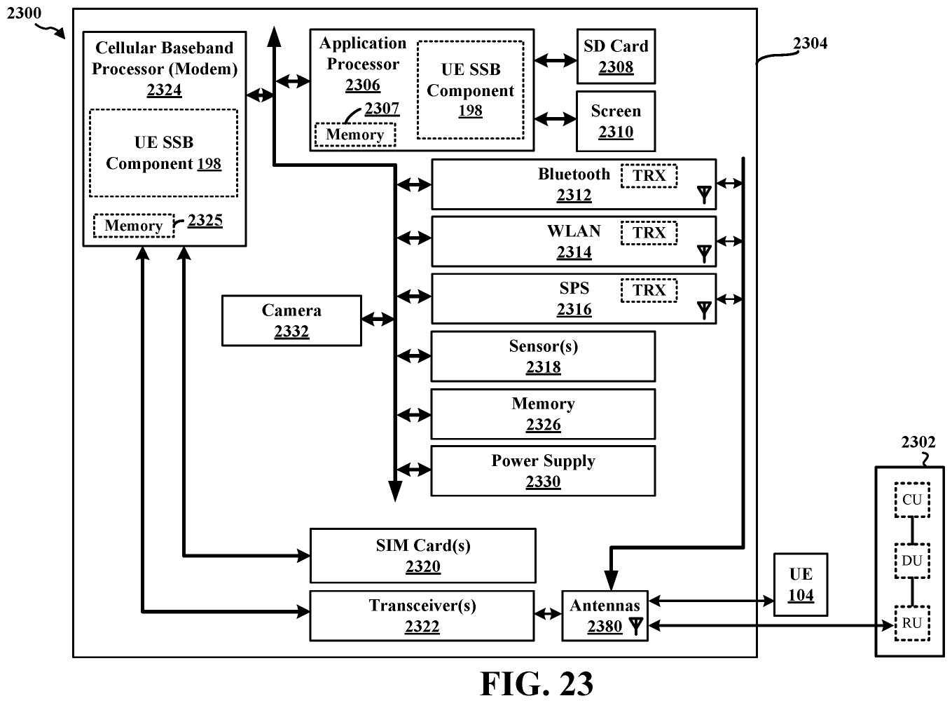

FIG. 21 is a flowchart 2100 of a method of wireless communication. The method may be performed by a UE (e.g., the UEs 104, and/or an apparatus 2304 of FIG. 23). The method may facilitate reducing UE complexity and reducing UE power consumption, for example, by reducing the number of symbols that the UE monitors when receiving SSBs and/or by reducing the number of hypotheses that the UE tries when performing blind decoding to receive the complete SSB.

At 2102, the UE monitors in a first resource for at least a part of a first portion of a first SSB of a non-terrestrial network and a second portion of the first SSB, the first resource being associated with a first beam, as described in connection with monitoring procedure 930 of FIG. 9. For example, 2102 may be performed by a cellular RF transceiver 2322/the UE SSB component 198 of the apparatus 2304 of FIG. 23.

At 2104, the UE monitors for a second SSB of the non-terrestrial network on a second beam in a second resource that overlaps at least in part with the second portion of the first SSB, as described in connection with the monitoring procedure 932 of FIG. 9. For example, 2104 may be performed by the cellular RF transceiver 2322/the UE SSB component 198 of the apparatus 2304 of FIG. 23.

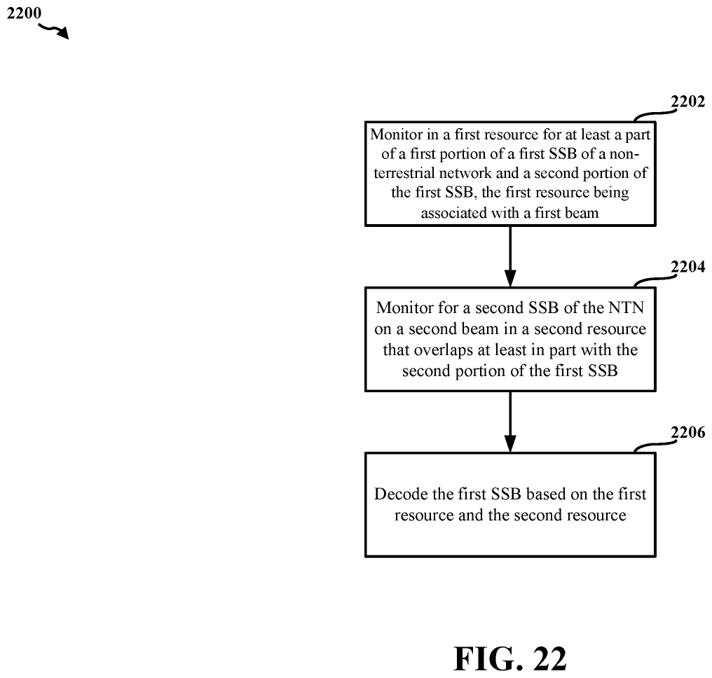

FIG. 22 is a flowchart 2200 of a method of wireless communication. The method may be performed by a UE (e.g., the UEs 104, and/or an apparatus 2304 of FIG. 23). The method may facilitate reducing UE complexity and reducing UE power consumption, for example, by reducing the number of symbols that the UE monitors when receiving SSBs and/or by reducing the number of hypotheses that the UE tries when performing blind decoding to receive the complete SSB.

At 2202, the UE monitors in a first resource for at least a part of a first portion of a first SSB of a non-terrestrial network and a second portion of the first SSB, the first resource being associated with a first beam, as described in connection with monitoring procedure 930 of FIG. 9. For example, 2202 may be performed by a cellular RF transceiver 2322/the UE SSB component 198 of the apparatus 2304 of FIG. 23.

In some examples, the second portion of the first SSB may precede the first portion of the first SSB.

In some examples, the second portion of the first SSB may follow the first portion of the first SSB.

In some examples, the second portion of the first SSB may have a fixed relationship in time to the first portion of the first SSB.

In some examples, monitoring for the first SSB is based on a single hypothesis for the second portion. In some examples, the single hypothesis may be based on a fixed relationship in time between the second portion of the first SSB and the first portion of the first SSB.

In some examples, the second portion of the first SSB is continuous in time or discontinuous in time.

In some examples, monitoring for the second portion of the first SSB may be based on support for reception in a reduced bandwidth.

At 2204, the UE monitors for a second SSB of the non-terrestrial network on a second beam in a second resource that overlaps at least in part with the second portion of the first SSB, as described in connection with the monitoring procedure 932 of FIG. 9. For example, 2204 may be performed by the cellular RF transceiver 2322/the UE SSB component 198 of the apparatus 2304 of FIG. 23.

In some examples, the second portion of the first SSB may overlap with the second resource of the second SSB based on at least one of: the first beam being a non-adjacent beam to the second beam, the first beam having a non-overlapping coverage area with the second beam, or a first SSB index being non-consecutive with a second SSB index.

In some examples, the second SSB includes a third portion and a fourth portion, and the second portion of the first SSB may overlap with the second resource for at least one of the third portion of the second SSB or the fourth portion of the second SSB.

In some examples, the second portion of the first SSB may be separated in time from the first portion of the first SSB and may overlap in time with one or more other SSBs on one or more other beams that are different than the first beam. In some such examples, the one or more other SSBs on the one or more other beams may have one or more SSB indexes that are non-consecutive with a first SSB index of the first SSB.

At 2206, the UE may decode the first SSB based on the first resource and the second resource, as described in connection with decoding procedure 934 of FIG. 9. For example, 2206 may be performed by the UE SSB component 198 of the apparatus 2304 of FIG. 23.

In some examples, the UE may include a first type of UE that is configured with the capability to decode the first SSB based on the first resource. For example, the first type of UE may include a higher capability UE.

In some examples, the EU may include a second type of UE that is configured with the capability to decode the first SSB based on the first resource and the second resource. For example, the first type of EU may include a reduced capability UE (e.g., a RedCap UE or an eRedCap UE).

FIG. 23 is a diagram 2300 illustrating an example of a hardware implementation for an apparatus 2304. The apparatus 2304 may be a UE, a component of a UE, or may implement UE functionality. In some aspects, the apparatus 2304 may include a cellular baseband processor 2324 (also referred to as a modem) coupled to one or more transceivers (e.g., a cellular RF transceiver 2322). The cellular baseband processor 2324 may include on-chip memory 2325. In some aspects, the apparatus 2304 may further include one or more subscriber identity modules (SIM) cards 2320 and an application processor 2306 coupled to a secure digital (SD) card 2308 and a screen 2310. The application processor 2306 may include on-chip memory 2307. In some aspects, the apparatus 2304 may further include a Bluetooth module 2312, a WLAN module 2314, an SPS module 2316 (e.g., GNSS module), one or more sensor modules 2318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2326, a power supply 2330, and/or a camera 2332. The Bluetooth module 2312, the WLAN module 2314, and the SPS module 2316 may include an on-chip transceiver (TRX) (or in some cases, just a receiver (RX)). The Bluetooth module 2312, the WLAN module 2314, and the SPS module 2316 may include their own dedicated antennas and/or utilize one or more antennas 2380 for communication. The cellular baseband processor 2324 communicates through transceiver(s) (e.g., the cellular RF transceiver 2322) via one or more antennas 2380 with the UEs 104 and/or with an RU associated with a network entity 2302. The cellular baseband processor 2324 and the application processor 2306 may each include a computer-readable medium/memory, such as the on-chip memory 2325, and the on-chip memory 2307, respectively. The additional memory modules 2326 may also be considered a computer-readable medium/memory. Each computer-readable medium/memory (e.g., the on-chip memory 2325, the on-chip memory 2307, and/or the additional memory modules 2326) may be non-transitory. The cellular baseband processor 2324 and the application processor 2306 are each responsible for general processing, including the execution of software stored on the computer-readable medium/memory. The software, when executed by the cellular baseband processor 2324/application processor 2306, causes the cellular baseband processor 2324/application processor 2306 to perform the various functions described supra. The computer-readable medium/memory may also be used for storing data that is manipulated by the cellular baseband processor 2324/application processor 2306 when executing software. The cellular baseband processor 2324/application processor 2306 may be a component of the UE 450 and may include the memory 460 and/or at least one of the TX processor 468, the RX processor 456, and the controller/processor 459. In one configuration, the apparatus 2304 may be a processor chip (modem and/or application) and include just the cellular baseband processor 2324 and/or the application processor 2306, and in another configuration, the apparatus 2304 may be the entire UE (e.g., see the UE 450 of FIG. 4) and include the additional modules of the apparatus 2304.

As discussed supra, the UE SSB component 198 is configured to monitor in a first resource for at least a part of a first portion of a first SSB of a non-terrestrial network and a second portion of the first SSB, the first resource being associated with a first beam. The UE SSB component 198 may also be configured to monitor for a second SSB of the non-terrestrial network on a second beam in a second resource that overlaps at least in part with the second portion of the first SSB.

The UE SSB component 198 may be within the cellular baseband processor 2324, the application processor 2306, or both the cellular baseband processor 2324 and the application processor 2306. The UE SSB component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 2304 may include a variety of components configured for various functions. For example, the UE SSB component 198 may include one or more hardware components that perform each of the blocks of the algorithm in the flowcharts of FIG. 21 and/or FIG. 22.

In one configuration, the apparatus 2304, and in particular the cellular baseband processor 2324 and/or the application processor 2306, includes means for monitoring in a first resource for at least a part of a first portion of a first SSB of a non-terrestrial network and a second portion of the first SSB, the first resource being associated with a first beam. The example apparatus 2304 also includes means for monitoring for a second SSB of the non-terrestrial network on a second beam in a second resource that overlaps at least in part with the second portion of the first SSB.

In another configuration, the example apparatus 2304 also includes means for decoding the first SSB.

The means may be the UE SSB component 198 of the apparatus 2304 configured to perform the functions recited by the means. As described supra, the apparatus 2304 may include the TX processor 468, the RX processor 456, and the controller/processor 459. As such, in one configuration, the means may be the TX processor 468, the RX processor 456, and/or the controller/processor 459 configured to perform the functions recited by the means.

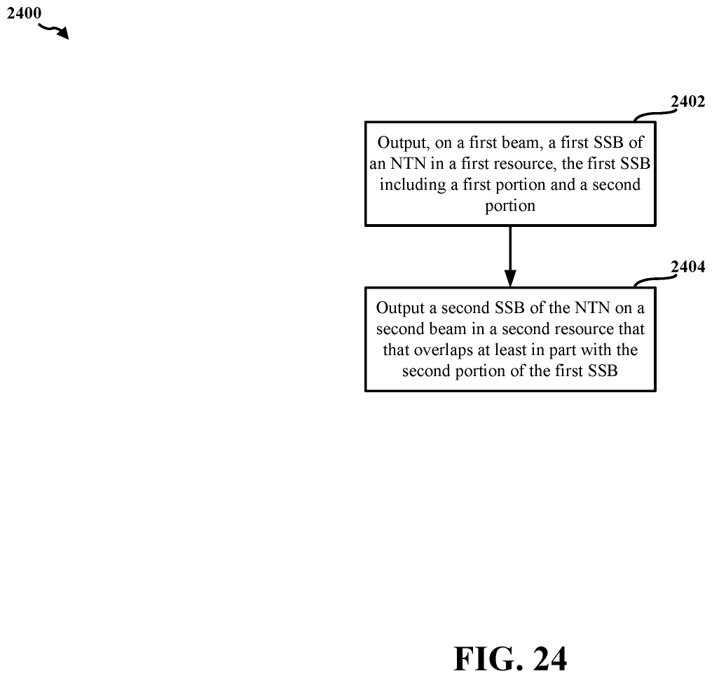

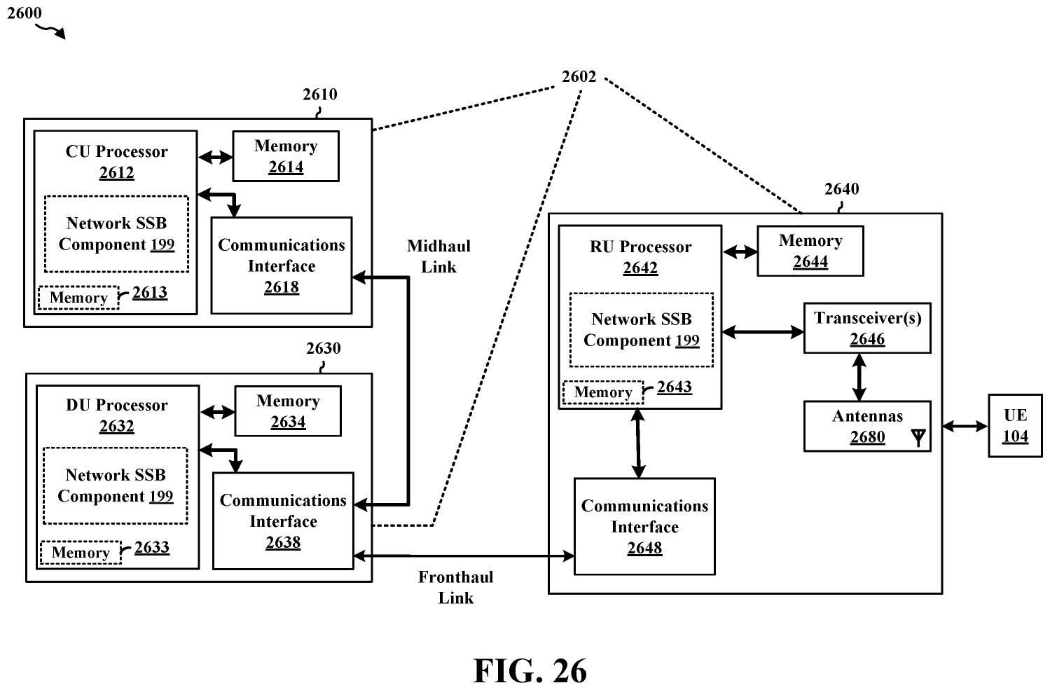

FIG. 24 is a flowchart 2400 of a method of wireless communication. The method may be performed by a network node (e.g., the base stations 102, and/or a network entity 2602 of FIG. 26). The method may facilitate reducing UE complexity and reducing UE power consumption, for example, by reducing the number of symbols that the UE monitors when receiving SSBs and/or by reducing the number of hypotheses that the UE tries when performing blind decoding to receive the complete SSB.

At 2402, the network node outputs, on a first beam, a first SSB of a non-terrestrial network in a first resource, the first SSB including a first portion and a second portion, as described in connection with the second SSB part-1 918 and the second SSB part-2 922 of FIG. 9. For example, 2402 may be performed by the network SSB component 199 of the network entity 2602 of FIG. 26.

At 2404, the network node outputs a second SSB of the non-terrestrial network on a second beam in a second resource that that overlaps at least in part with the second portion of the first SSB, as described in connection with the first SSB 914 and the third SSB 926 of FIG. 9. For example, 2404 may be performed by the network SSB component 199 of the network entity 2602 of FIG. 26.

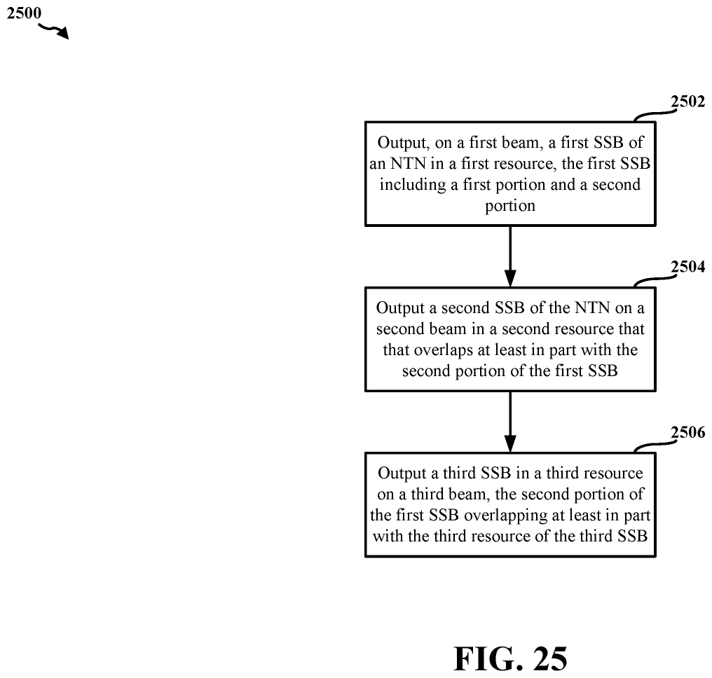

FIG. 25 is a flowchart 2500 of a method of wireless communication. The method may be performed by a network node (e.g., the base stations 102, and/or a network entity 2602 of FIG. 26). The method may facilitate reducing UE complexity and reducing UE power consumption, for example, by reducing the number of symbols that the UE monitors when receiving SSBs and/or by reducing the number of hypotheses that the UE tries when performing blind decoding to receive the complete SSB.

At 2502, the network node outputs, on a first beam, a first SSB of a non-terrestrial network in a first resource, the first SSB including a first portion and a second portion, as described in connection with the second SSB part-1 918 and/or the second SSB part-2 922 of FIG. 9. For example, 2502 may be performed by the network SSB component 199 of the network entity 2602 of FIG. 26.

In some examples, the second portion of the first SSB may precede the first portion of the first SSB in a time domain.

In some examples, the second portion of the first SSB may follow the first portion of the first SSB in a time domain.

In some examples, the second portion of the first SSB may have a fixed relationship in time with the first portion of the first SSB.

In some examples, the second portion of the first SSB is continuous in time or discontinuous in time.

In some examples, the second portion of the first SSB may be configured at least for a type of UE that supports reception in a reduced bandwidth.

At 2504, the network node outputs a second SSB of the non-terrestrial network on a second beam in a second resource that that overlaps at least in part with the second portion of the first SSB, as described in connection with the second SSB part-1 918 and/or the second SSB part-2 922 of FIG. 9. For example, 2504 may be performed by the network SSB component 199 of the network entity 2602 of FIG. 26.

In some examples, the second portion of the first SSB may overlap in at least one of time or frequency with the second resource of the second SSB.

In some examples, the second SSB may include a third portion and a fourth portion, and the second portion of the first SSB may overlap with the second resource for at least one of the third portion of the second SSB or the third portion of the second SSB.

In some examples, the second portion of the first SSB may overlap with the second resource of the second SSB based on one of: the first beam being a non-adjacent beam to the second beam, the first beam having a non-overlapping coverage area with the second beam, or a first SSB index being non-consecutive with a second SSB index.

In some examples, the second portion of the first SSB may be separated in time from the first portion of the first SSB and may overlap in time with one or more SSBs on one or more other beams than the first beam. In some such examples, the one or more SSBs on the one or more other beams have one or more SSB indexes that are non-consecutive with a first SSB index of the first SSB.

In some examples, the second portion of the first SSB precedes the first portion of the first SSB and at least partially overlaps resources for one or more SSBs on one or more other beams that are different from the first beam. In some examples, the second portion of the first SSB follows the first portion of the first SSB and at least partially overlaps resources for one or more SSBs on one or more other beams that are different from the first beam.

At 2506, the network node may output a third SSB in a third resource on a third beam, where the second portion of the first SSB may overlap at least in part with the third resource of the third SSB, as described in connection with the second SSB part-1 918 and/or the second SSB part-2 922 of FIG. 9. For example, 2506 may be performed by the network SSB component 199 of the network entity 2602 of FIG. 26.

In some examples, the second portion of the first SSB may overlap with at least one of a fifth portion sixth portion of the third SSB.

FIG. 26 is a diagram 2600 illustrating an example of a hardware implementation for a network entity 2602. The network entity 2602 may be a BS, a component of a BS, or may implement BS functionality. The network entity 2602 may include at least one of a CU 2610, a DU 2630, or an RU 2640. For example, depending on the layer functionality handled by the network SSB component 199, the network entity 2602 may include the CU 2610; both the CU 2610 and the DU 2630; each of the CU 2610, the DU 2630, and the RU 2640; the DU 2630; both the DU 2630 and the RU 2640; or the RU 2640. The CU 2610 may include a CU processor 2612. The CU processor 2612 may include on-chip memory 2613. In some aspects, may further include additional memory modules 2614 and a communications interface 2618. The CU 2610 communicates with the DU 2630 through a midhaul link, such as an F1 interface. The DU 2630 may include a DU processor 2632. The DU processor 2632 may include on-chip memory 2633. In some aspects, the DU 2630 may further include additional memory modules 2634 and a communications interface 2638. The DU 2630 communicates with the RU 2640 through a fronthaul link. The RU 2640 may include an RU processor 2642. The RU processor 2642 may include on-chip memory 2643. In some aspects, the RU 2640 may further include additional memory modules 2644, one or more transceivers 2646, antennas 2680, and a communications interface 2648. The RU 2640 communicates with the UEs 104. The on-chip memories (e.g., the on-chip memory 2613, the on-chip memory 2633, and/or the on-chip memory 2643) and/or the additional memory modules (e.g., the additional memory modules 2614, the additional memory modules 2634, and/or the additional memory modules 2644) may each be considered a computer-readable medium/memory. Each computer-readable medium/memory may be non-transitory. Each of the CU processor 2612, the DU processor 2632, the RU processor 2642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the network SSB component 199 is configured to output, on a first beam, a first SSB of a non-terrestrial network in a first resource, the first SSB including a first portion and a second portion. The network SSB component 199 may also be configured to output a second SSB of the non-terrestrial network on a second beam in a second resource that that overlaps at least in part with the second portion of the first SSB.

The network SSB component 199 may be within one or more processors of one or more of the CU 2610, DU 2630, and the RU 2640. The network SSB component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 2602 may include a variety of components configured for various functions. For example, the network SSB component 199 may include one or more hardware components that perform each of the blocks of the algorithm in the flowcharts of FIG. 24 and/or FIG. 25.

In one configuration, the network entity 2602 includes means for outputting, on a first beam, a first SSB of a non-terrestrial network in a first resource, the first SSB including a first portion and a second portion. The example network entity 2602 also includes means for outputting a second SSB of the non-terrestrial network on a second beam in a second resource that that overlaps at least in part with the second portion of the first SSB.

In another configuration, the example network entity 2602 also includes means for outputting a third SSB in a third resource on a third beam, wherein the second portion of the first SSB overlaps at least in part with the third resource of the third SSB.

The means may be the network SSB component 199 of the network entity 2602 configured to perform the functions recited by the means. As described supra, the network entity 2602 may include the TX processor 416, the RX processor 470, and the controller/processor 475. As such, in one configuration, the means may be the TX processor 416, the RX processor 470, and/or the controller/processor 475 configured to perform the functions recited by the means.

Aspects disclosed herein provide techniques for utilizing characteristics associated with an NTN to improve reception of SSBs for NTN reduced capability UEs (e.g., reduced capability UEs operating in an NTN). For example, aspects disclosed herein provide techniques for reducing power consumption of a reduced capability UE, for example, by reducing the number of symbols that the reduced capability UE may monitor to receive an SSB. Additionally, or alternatively, the techniques disclosed herein may reduce UE complexity, for example, by reducing the number of hypotheses that the reduced capability UE may try when performing blind decoding.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular in the previous description and the claims does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: monitoring in a first resource for at least a part of a first portion of a first SSB of a non-terrestrial network and a second portion of the first SSB, the first resource being associated with a first beam; and monitoring for a second SSB of the non-terrestrial network on a second beam in a second resource that overlaps at least in part with the second portion of the first SSB.

Aspect 2 is the method of aspect 1, further including that the second portion of the first SSB has a fixed relationship in time to the first portion of the first SSB.

Aspect 3 is the method of any of aspects 1 and 2, further including that the second SSB includes a third portion and a fourth portion, and the second portion of the first SSB overlaps with the second resource for at least one of the third portion of the second SSB or the fourth portion of the second SSB.

Aspect 4 is the method of any of aspects 1 to 3, further including that monitoring for the first SSB is based on a single hypothesis for the second portion.

Aspect 5 is the method of aspect 4, further including that the single hypothesis is based on a fixed relationship in time between the second portion of the first SSB and the first portion of the first SSB.

Aspect 6 is the method of any of aspects 1 to 5, further including that the second portion of the first SSB overlaps with the second resource of the second SSB based on at least one of: the first beam being a non-adjacent beam to the second beam, the first beam having a non-overlapping coverage area with the second beam, or a first SSB index being non-consecutive with a second SSB index.

Aspect 7 is the method of any of aspects 1 to 6, further including that the second portion of the first SSB precedes the first portion of the first SSB.

Aspect 8 is the method of any of aspects 1 to 6, further including that the second portion of the first SSB follows the first portion of the first SSB.

Aspect 9 is the method of any of aspects 1 to 8, further including that the second portion of the first SSB is separated in time from the first portion of the first SSB and overlaps in time with one or more other SSBs on one or more other beams that are different than the first beam, where the one or more other SSBs on the one or more other beams have one or more SSB indexes that are non-consecutive with a first SSB index of the first SSB.

Aspect 10 is the method of any of aspects 1 to 9, further including that the second portion of the first SSB is continuous in time or discontinuous in time.

Aspect 11 is the method of any of aspects 1 to 10, further including that monitoring for the second portion of the first SSB is based on support for reception in a reduced bandwidth.

Aspect 12 is an apparatus for wireless communication at a UE including at least one processor coupled to a memory and configured to implement any of aspects 1 to 11.

In aspect 13, the apparatus of aspect 12 further includes at least one antenna coupled to the at least one processor.

In aspect 14, the apparatus of aspect 12 or 13 further includes a transceiver coupled to the at least one processor.

Aspect 15 is an apparatus for wireless communication including means for implementing any of aspects 1 to 11.

In aspect 16, the apparatus of aspect 15 further includes at least one antenna coupled to the means to perform the method of any of aspects 1 to 11.

In aspect 17, the apparatus of aspect 15 or 16 further includes a transceiver coupled to the means to perform the method of any of aspects 1 to 11.

Aspect 18 is a non-transitory computer-readable storage medium storing computer executable code, where the code, when executed, causes a processor to implement any of aspects 1 to 11.

Aspect 19 is a method of wireless communication at a network node, including: outputting, on a first beam, a first SSB of a non-terrestrial network in a first resource, the first SSB including a first portion and a second portion; and outputting a second SSB of the non-terrestrial network on a second beam in a second resource that that overlaps at least in part with the second portion of the first SSB.

Aspect 20 is the method of aspect 19, further including that the second portion of the first SSB has a fixed relationship in time with the first portion of the first SSB.

Aspect 21 is the method of any of aspects 19 and 20, further including that the second portion of the first SSB overlaps in at least one of time or frequency with the second resource of the second SSB.

Aspect 22 is the method of any of aspects 19 to 21, further including that the second SSB includes a third portion and a fourth portion, and the second portion of the first SSB overlaps with the second resource for at least one of the third portion of the second SSB or the third portion of the second SSB.

Aspect 23 is the method of any of aspects 19 to 22, further including: outputting a third SSB in a third resource on a third beam, where the second portion of the first SSB overlaps at least in part with the third resource of the third SSB.

Aspect 24 is the method of aspect 23, further including that the second portion of the first SSB overlaps with at least one of a fifth portion sixth portion of the third SSB.

Aspect 25 is the method of any of aspects 19 to 24, further including that the second portion of the first SSB overlaps with the second resource of the second SSB based on one of: the first beam being a non-adjacent beam to the second beam, the first beam having a non-overlapping coverage area with the second beam, or a first SSB index being non-consecutive with a second SSB index.

Aspect 26 is the method of any of aspects 19 to 25, further including that the second portion of the first SSB precedes the first portion of the first SSB in a time domain.

Aspect 27 is the method of any of aspects 19 to 25, further including that the second portion of the first SSB follows the first portion of the first SSB in a time domain.

Aspect 28 is the method of any of aspects 19 to 27, further including that the second portion of the first SSB is separated in time from the first portion of the first SSB and overlaps in time with one or more SSBs on one or more other beams than the first beam, where the one or more SSBs on the one or more other beams have one or more SSB indexes that are non-consecutive with a first SSB index of the first SSB.

Aspect 29 is the method of any of aspects 19 to 28, further including that the second portion of the first SSB is one of preceding or following the first portion of the first SSB and at least partially overlaps resources for one or more SSBs on one or more other beams that are different from the first beam.

Aspect 30 is the method of any of aspects 19 to 29, further including that the second portion of the first SSB is continuous in time or discontinuous in time.

Aspect 31 is the method of any of aspects 19 to 30, further including that the second portion of the first SSB is configured at least for a type of user equipment (UE) that supports reception in a reduced bandwidth.

Aspect 32 is an apparatus for wireless communication at a network node including at least one processor coupled to a memory and configured to implement any of aspects 19 to 31.

In aspect 33, the apparatus of aspect 32 further includes at least one antenna coupled to the at least one processor.

In aspect 34, the apparatus of aspect 32 or 33 further includes a transceiver coupled to the at least one processor.

Aspect 35 is an apparatus for wireless communication including means for implementing any of aspects 19 to 31.

In aspect 36, the apparatus of aspect 35 further includes at least one antenna coupled to the means to perform the method of any of aspects 19 to 31.

In aspect 37, the apparatus of aspect 35 or 36 further includes a transceiver coupled to the means to perform the method of any of aspects 19 to 31.

Aspect 38 is a non-transitory computer-readable storage medium storing computer executable code, where the code, when executed, causes a processor to implement any of aspects 19 to 31.

What is claimed is:

1. An apparatus for wireless communication at a user equipment (UE), comprising:
a memory; and
at least one processor coupled to the memory and configured to:
monitor in a first resource for at least a part of a first portion of a first synchronization signal block (SSB) of a non-terrestrial network and a second portion of the first SSB, the first resource being associated with a first beam; and
monitor for a second SSB of the non-terrestrial network on a second beam in a second resource that overlaps at least in part with the second portion of the first SSB.

2. The apparatus of claim 1, wherein the second portion of the first SSB has a fixed relationship in time to the first portion of the first SSB.

3. The apparatus of claim 1, wherein the second SSB includes a third portion and a fourth portion, and the second portion of the first SSB overlaps with the second resource for at least one of the third portion of the second SSB or the fourth portion of the second SSB.

4. The apparatus of claim 1, further comprising:
at least one antenna coupled to the at least one processor, wherein the at least one processor is further configured to:
monitor for the first SSB based on a single hypothesis for the second portion.

5. The apparatus of claim 4, wherein the single hypothesis is based on a fixed relationship in time between the second portion of the first SSB and the first portion of the first SSB.

6. The apparatus of claim 1, wherein the second portion of the first SSB overlaps with the second resource of the second SSB based on at least one of:
the first beam being a non-adjacent beam to the second beam,
the first beam having a non-overlapping coverage area with the second beam, or a first SSB index being non-consecutive with a second SSB index.

7. The apparatus of claim 1, wherein the second portion of the first SSB is separated in time from the first portion of the first SSB and overlaps in time with one or more other SSBs on one or more other beams that are different than the first beam, wherein the one or more other SSBs on the one or more other beams have one or more SSB indexes that are non-consecutive with a first SSB index of the first SSB.

8. The apparatus of claim 1, wherein to monitor for the second portion of the first SSB is based on support for reception in a reduced bandwidth.

9. A method of wireless communication at a user equipment (UE), comprising:
monitoring in a first resource for at least a part of a first portion of a first synchronization signal block (SSB) of a non-terrestrial network and a second portion of the first SSB, the first resource being associated with a first beam; and
monitoring for a second SSB of the non-terrestrial network on a second beam in a second resource that overlaps at least in part with the second portion of the first SSB.

10. The method of claim 9, wherein the second portion of the first SSB has a fixed relationship in time to the first portion of the first SSB.

11. The method of claim 9, wherein the second SSB includes a third portion and a fourth portion, and the second portion of the first SSB overlaps with the second resource for at least one of the third portion of the second SSB or the fourth portion of the second SSB.

12. The method of claim 9, wherein monitoring for the first SSB is based on a single hypothesis for the second portion.

13. The method of claim 12, wherein the single hypothesis is based on a fixed relationship in time between the second portion of the first SSB and the first portion of the first SSB.

14. The method of claim 9,
wherein the second portion of the first SSB overlaps with the second resource of the second SSB based on at least one of:
the first beam being a non-adjacent beam to the second beam,
the first beam having a non-overlapping coverage area with the second beam, or
a first SSB index being non-consecutive with a second SSB index.

15. The method of claim 9, wherein the second portion of the first SSB is separated in time from the first portion of the first SSB and overlaps in time with one or more other SSBs on one or more other beams that are different than the first beam, wherein the one or more other SSBs on the one or more other beams have one or more SSB indexes that are non-consecutive with a first SSB index of the first SSB.

16. The method of claim 9, wherein monitoring for the second portion of the first SSB is based on support for reception in a reduced bandwidth.

17. An apparatus for wireless communication at a network node, comprising:
a memory; and
at least one processor coupled to the memory and configured to:
output, on a first beam, a first synchronization signal block (SSB) of a non-terrestrial network in a first resource, the first SSB including a first portion and a second portion; and
output a second SSB of the non-terrestrial network on a second beam in a second resource that that overlaps at least in part with the second portion of the first SSB.

18. The apparatus of claim 17, wherein the second portion of the first SSB has a fixed relationship in time with the first portion of the first SSB.

19. The apparatus of claim 17, wherein the second portion of the first SSB overlaps in at least one of time or frequency with the second resource of the second SSB.

20. The apparatus of claim 17, wherein the second SSB includes a third portion and a fourth portion, and the second portion of the first SSB overlaps with the second resource for at least one of the third portion of the second SSB or the third portion of the second SSB.

21. The apparatus of claim 17, further comprising:
at least one antenna coupled to the at least one processor, wherein the at least one processor is further configured to:
output a third SSB in a third resource on a third beam, wherein the second portion of the first SSB overlaps at least in part with the third resource of the third SSB.

22. The apparatus of claim 17, wherein the second portion of the first SSB overlaps with the second resource of the second SSB based on one of:
the first beam being a non-adjacent beam to the second beam,
the first beam having a non-overlapping coverage area with the second beam, or
a first SSB index being non-consecutive with a second SSB index.

23. The apparatus of claim 17, wherein the second portion of the first SSB is separated in time from the first portion of the first SSB and overlaps in time with one or more SSBs on one or more other beams than the first beam, wherein the one or more SSBs on the one or more other beams have one or more SSB indexes that are non-consecutive with a first SSB index of the first SSB.

24. The apparatus of claim 17, wherein the second portion of the first SSB is one of preceding or following the first portion of the first SSB and at least partially overlaps resources for one or more SSBs on one or more other beams that are different from the first beam.

25. The apparatus of claim 17, wherein the second portion of the first SSB is configured at least for a type of user equipment (UE) that supports reception in a reduced bandwidth.

26. A method of wireless communication at a network node, comprising:
outputting, on a first beam, a first synchronization signal block (SSB) of a non-terrestrial network in a first resource, the first SSB including a first portion and a second portion; and
outputting a second SSB of the non-terrestrial network on a second beam in a second resource that that overlaps at least in part with the second portion of the first SSB.

27. The method of claim 26, wherein the second portion of the first SSB overlaps in at least one of time or frequency with the second resource of the second SSB.

28. The method of claim 26, wherein the second portion of the first SSB is separated in time from the first portion of the first SSB and overlaps in time with one or more SSBs on one or more other beams than the first beam, wherein the one or more SSBs on the one or more other beams have one or more SSB indexes that are non-consecutive with a first SSB index of the first SSB.

29. The method of claim 26, wherein the second portion of the first SSB is one of preceding or following the first portion of the first SSB and at least partially overlaps resources for one or more SSBs on one or more other beams that are different from the first beam.

30. The method of claim 26, wherein the second portion of the first SSB is configured at least for a type of user equipment (UE) that supports reception in a reduced bandwidth.
